(19) United States
(12) Patent Application Publication
(10) Pub. No.: US 2015/0006260 A1
(43) Pub. Date: Jan. 1, 2015

(54) COMPUTING SYSTEM, CLIENT COMPUTING DEVICE, COMPUTER READABLE MEDIUM AND COMPUTER IMPLEMENTED METHOD FOR ORGANIZATIONAL PERFORMANCE ASSESSMENT

(71) Applicant: ICOM4 Pty Ltd, Sydney (AU)

(72) Inventor: Tanya Michelle Harris, Sydney (AU)

(21) Appl. No.: 14/315,801

(22) Filed: Jun. 26, 2014

(30) Foreign Application Priority Data
Jun. 28, 2013 (AU) 2013902407

(51) Int. Cl. G06Q 10/06

(52) U.S. Cl. CPC G06Q 10/06393
USPC 705/7.39

(57) ABSTRACT

A computer system for assessing the performance of an organisation is configured to load member data and assessment data; assign an assessment type to each member using the member assessment data; send question data including a series of performance criteria questions to each member, which include a set of performance statements provided in contrasting ways such that each member provides two input scores for each performance statement; receive input scores including two scores for each performance statement; store the input scores for each member as results data, which is associated with at least one of the assessment type and the performance statements; process the results data to provide output data by calculating an average difference between the two scores providing a discrepancy metric for each of the set of performance statements, and send the output data including the discrepancy metric representing the performance of the organisation.

### TECHNICAL FIELD

The invention relates to a computing system, client computing device, computer readable medium, and a computer implemented method for assessing the performance of an organisation. More specifically, the invention relates to a computing system, client computing device, computer readable medium, and a computer implemented method for determining a discrepancy metric or index for the organisation.

### BACKGROUND

Organisations such as companies often conduct surveys or questionaries to gather feedback from employees in relation to a variety issues. A series of questions are typically asked to each employee about how they rate the company or the company management in areas such as job satisfaction, future prospects and perceived competency of management.

Typically, the employees which may include both management or workforce level employees are each provided with a common set of questions and each question is displayed to the employee with a scoring or rating system. For, example, 1—Never, 2—Sometimes, 3—More often than not, 4—most of the time, and 5—Always.

A computer system such as a server based system with remote client terminals is typically utilised to send the questions, present the questions to the employee via a graphical user interface of the remote client terminal, record the answers or response score data to the questions and store the score data.

Once the survey is complete, the computer system may be utilised to perform data processing operations on the stored score data to collate the score data from a large number of employees. For example, reports or graphs may be provided which show an averaged response of the employees to the questions or topics which were provided in the survey.

A disadvantage with these survey methods is that they provide insufficient guidance as to where a company should place focus, in particular, in relation to the performance of the company.

Another disadvantage is that these methods do not provide visibility or guidance as to which areas of the company have the greatest or least problems nor do these survey methods provide quantifiable metrics or indexes to identify the areas of the company that have the greatest or least problems.

The invention described herein seeks to provide a computer system, a client computing device, a computer readable medium, and a computer implemented which seek to overcome at least one of the above disadvantages or at least provide a useful alternative.

### SUMMARY

In accordance with a first aspect, there is provided a computer system for assessing the performance of an organisation in relation to a series of performance criteria questions presented to a plurality of members of the organisation. The computer system may be configured by a computer program to perform one or more of the following steps.

The steps may include: Loading, in memory, member data and assessment data; Assigning, in a processor, an assessment type to each of the plurality of members using the member data and the assessment data; Sending, via an interface, question data including the series of performance criteria questions to each of the plurality of members, the series of performance criteria questions including a set of performance statements and each of the set of performance statements are provided in contrasting ways such that each of the plurality of members provides two input scores for each of the set of performance statements.

The steps may also include: receiving, via the interface, input scores including two scores for each of the set of performance statements; Storing, in a storage device, the input scores for each of the plurality of members as results data, the results data being associated with at least one of the assessment type and the performance statements; Processing, in a processor, the results data from the plurality of members, to provide output data by calculating an average difference between the two scores for each of the performance statements thereby providing a discrepancy metric for each of the set of performance statements, and Sending, via the interface, the output data including the discrepancy metric representing the performance of the organisation in relation to the series of performance criteria questions presented to the plurality of members.

The steps may also include: presenting, via the interface, the output data including the average result score values in at least one of a report, graph, chart, table or list so as to indicate the performance of the organisation in relation to the series of performance criteria questions presented to the plurality of members.

In one aspect, the step of processing includes: Calculating, an average of the first of the two input scores for each of the set of performance statements for the plurality of members to provide a set of first averaged values for each of the performance statements; Calculating, an average of the second of the two input scores for each of the set of performance statements for the plurality of members to provide a second set of averaged values for each of the performance statements; and wherein the output data includes the first set of averaged values, the second set of averaged values, the discrepancy metric and the associated set of performance statements.

In another aspect, at the step of sending the question data, a first set of the selection of the series of performance criteria questions are sent to each of the plurality of members at a first time and a second set of the series of performance criteria questions are send to each of the plurality of members at a second time.

In another aspect, the first set includes first questions presented to each of the plurality of members in one of the two contrasting ways and the second set includes second questions presented to each of the plurality of members in the other of the two contrasting ways.

In another aspect, the first time and second time are each pre-defined times and wherein the computer system is configured to monitor the pre-defined times so as to automatically send the question data to each of the plurality of members with the first and second sets of questions at the first and second times.

In another aspect, the member data includes member types including at least a first member type and a second member type, and wherein in the step of processing, the discrepancy metric for each of the performance statements is associated with the member types of each of the plurality of members.

In another aspect, the output data includes the discrepancy metrics for the first member type and the second member type.

In another aspect, the discrepancy metrics are presented in at least one of a comparative chart, table or report.

In another aspect, at the step of processing, a further discrepancy metric calculated by determining the difference between the discrepancy metric for the first member type and the second member type.

In another aspect, the member types include a workforce member, middle management member and a senior executive member, wherein first member includes at least one said member types and the second member type includes at least one other said member types.

In another aspect, the set of performance statements are subcategories of a main set of performance categories; and wherein the step of processing includes calculation of a consolidated discrepancy metric for each of the main set of performance categories by calculating an average discrepancy metric of each of the set of performance statements associated with a particular one of the main set of performance categories; and wherein the output data includes the consolidated discrepancy metric for each of the main set of performance categories.

In another aspect, at the step of processing, the performance statements are ranked according to the value of the discrepancy metric for each of the performance statements; and wherein in the step presenting, the output data includes at least one of a table, graph or list which shows the ranked performance statements.

In another aspect, the two contrasting ways of presenting the performance statement include presenting each performance statement as a desire based question and an experience based question; and wherein the discrepancy metric is determined by subtracting the input score of the experience based question from the input score of the desire based question.

In another aspect, the member type data relates the member to a type of member including workforce, executive, management, team leader.

In another aspect, the member type data relates the member to company tier value including at least one of location and department.

In another aspect, the output data is presented to display results data associated with at least one of the type of member and the company tier value.

In another aspect, the computer system includes a processor module, a memory device for storing digital data including a computer program code, the memory device being configured to be accessible by the processor; a data interface connected to the processing module and a database connection configured to be accessible by the processor, wherein the processor is controlled by the computer program code to carry out the steps.

In another aspect, the computer system is server based, having a server in communication with remote client terminals from which the plurality of members are presented with the series of performance criteria questions.

In another aspect, the computer system is a webserver.

In another aspect, wherein the series of performance criteria questions are associated with four main performance categories and each of the four main performance categories includes an associated four of the set of performance statements.

In another aspect, the output data includes data to display a wheel or circular graph, and wherein the graph includes four quadrants associated with each of the four main performance categories and wherein each of the four quadrants is divided into four segments for displaying results data associated with each of the performance statements.

In another aspect, the step of processing includes, the step of calculating a first average score by calculating the numerical average of the first of the two input scores for each of the set of performance statements, and calculating a second average score of the second of the two input scores by calculating the numerical average of the second of the two input scores for each of the set of performance statements thereby providing average result score values.

In another aspect, wherein each of the four segments of the circular display is divided to form half segments, and wherein each of the half segments are configured to respectively display one of the first and second averaged scores associated with the performance statement of the segment.

In another aspect, wherein the discrepancy metric associated with each of the set of performance statements is calculated by determining the difference between the first average score and the second average score.

In another aspect, wherein discrepancy metric is displayed for each of the segments of the circular graph.

In accordance with a second aspect, there is provided client computing device for assessing the performance of an organisation in relation to a series of performance criteria questions presented to a plurality of members of the organisation, the client computing device including a network interface for sending and receiving data and being in communication, across a data network, to the computing system as is described above.

In accordance with a third aspect, there is provided a computer system for assessing the performance of an organisation in relation to a series of performance criteria questions presented to a plurality of members of the organisation. The computer system may be configured by a computer program to perform one or more of the following steps.

The steps may include: Loading, in memory, an assessment type including the series of performance criteria questions; Sending, via an interface, question data including a series of performance criteria questions to each of the plurality of members, the series of performance criteria questions including a set of performance statements, wherein each of the set of performance statements is arranged to provide two associated contrasting statements; Receiving, via the interface, input scores including two scores for each of the two associated contrasting statements of the set of performance statements; Storing, in a storage device, the input scores for each of the members as results data, the results data being associated with at least one of the assessment type and the performance statements; Processing, in a processor, the results data from the plurality of members, to provide output data by calculating an average difference between the two scores for each of the performance statements thereby providing a discrepancy metric for each performance statement, and Sending, via the interface, the discrepancy metric so as to indicate the performance of the organisation in relation to the series of performance criteria questions presented to the plurality of members.

In one aspect, the step of processing includes: Loading the results data for the plurality of members; Calculating, an average of the first of the two input scores for each of the set of performance statements for the plurality of members to provide a set of first averaged values for each of the performance statements; Calculating, an average of the second of the two input scores for each of the set of performance statements for the plurality of members to provide a second set of averaged value for each of the performance statements; Calculating, the discrepancy metric by determining the difference between the set of first averaged values and the second set of averaged values thereby providing an average discrepancy metric for each of the performance statements.

In another aspect, at the step of processing, the performance statements are ranked according to the value of the discrepancy average metric for each of the performance statements; and wherein the output data includes at least one of a table, graph or list which shows the ranked performance statements.

In another aspect, the two contrasting ways of presenting the performance statement include presenting each performance statement as a first desire based question and a second experience based question; and wherein the discrepancy metric is determined by subtracting the input score of the second experience based question from the input score of the first desire based question.

In another aspect, at the step of presenting, via an interface, the selection of the series of performance criteria questions, an administration user accesses the computer system and assigns the selection of questions to the member.

In another aspect, the steps may include: Loading, in memory, member data and assessment data; Determining, in the processor, a member type from the member data and using the member type to determine an assessment type for each of the plurality of members from the assessment data, Presenting, via the interface, a selection of the performance statements to each of the plurality of members, the selection being based on the assigned assessment type; Recording, in memory, input scores from each of the plurality of members in response to the selection of the performance statements; Storing, in the database, the input scores for each of the plurality of members as results value data, the values being associated with at least one of the member type, assessment type and the selection of performance statements; Processing the results value data, so as to determine a further average discrepancy metrics associated with at least one of the member type, assessment type and the selection of performance statements.

In another aspect, the computer system includes including a processor module, a memory device for storing digital data including a computer program code, the memory device being configured to be accessible by the processor; a data interface connected to the processing module and a database connection configured to be accessible by the processor, wherein the processor is controlled by the computer program code to carry out the steps.

In another aspect, the computer system is server based, having a server in communication with remote client terminals from which the plurality of members are presented with the series of performance criteria questions.

In accordance with a fourth aspect, there is provided a server system including a computer system as described above, the server system being in communication with a remote client terminal from which the plurality of members are presented with the series of performance criteria questions.

In accordance with a fifth aspect, there is provided a client terminal device for communication with the computer system as defined above, the client terminal device being utilised by the member to provide input data to the computer system.

In accordance with a sixth aspect, there is provided a computer readable storage medium for a computer system, the computer readable storage medium including a computer program which configures the computer system to carry out the steps as defined above.

In accordance with a seventh aspect, there is provided a computer readable medium for assessing the performance of an organisation in relation to a series of performance criteria questions presented to a plurality of members of the organisation, the computer readable storage medium having computer program code instructions recorded thereon, the computer program code instructions including: Instructions for loading, in memory, an assessment type including the series of performance criteria questions; Instructions for sending, via an interface, question data including a series of performance criteria questions to each of the plurality of members, the series of performance criteria questions including a set of performance statements, wherein each of the set of performance statements is arranged to provide two contrasting statements; Instructions for receiving, via the interface, input scores including two scores for each of the two associated contrasting statements for each of the set of performance statements; Instructions for storing, in memory, the input scores for each of the plurality of members as results data, the results data being associated with at least one of the assessment type and the performance statements; Instructions for processing, in a processor, the results data from the plurality of members, to provide output data by calculating an average difference between the two scores for each of the performance statements thereby providing a discrepancy metric for each performance statement, and Instructions for sending, via the interface, the discrepancy metric so as to indicate the performance of the organisation in relation to the series of performance criteria questions presented to the plurality of members.

In accordance with an eighth aspect, there is provided a computer implemented method for assessing the performance of an organisation in relation to a series of performance criteria questions presented to a plurality of members of the organisation. The method may include a computer system which is configured by a computer program to perform one or more of the following steps.

The steps may include: Loading, in memory, an assessment type including the series of performance criteria questions; Providing, via an interface, the series of performance criteria questions to each of the plurality of members, the series of performance criteria questions including a set of performance statements and each performance statement is presented to each of the members in two contrasting ways such that the member provides two input scores for each of the performance statements; Recording, in memory, the two input scores for each of the plurality of members in response to each of the set of performance statements; Storing, in a database, the two input scores as results value data, the values being associated with at least one of the assessment type and the performance statements; Processing, in the processor, the results data from the plurality of members, to provide output data by calculating an average difference between the two scores for each performance statements thereby providing a discrepancy metric for each performance statement, and Presenting, via a data output, the discrepancy metric so as to indicate the performance of the organisation in relation to the series of performance criteria questions presented to the plurality of members.

In accordance with a ninth aspect, there is provided a method for workforce planning of a group of employees within a company structure using a computer device. The computer device may include a processor module, a memory device for storing digital data including a computer program code, the memory device being configured to be accessible by the processor; a data interface connected to the processing module and a database connection configured to be accessible by the processor, wherein the processor is controlled by the computer program code to carry out one or more of the following steps.

The steps may include a) Receiving, via the data interface, employee data for an employee in the group; b) Accessing, via the database connection, company structure data, loading the company structure data, and processing the employee data and company data to determine a tier level identifier for the employee; c) Accessing, via the database connection, question data, loading the question data and processing the question data to determine a set of questions which are specific to the tier level identifier, the set of questions including a series of question types wherein each question type includes at least one desire based question and at least one experience based question; d) Providing, via the data interface, the sequence of questions to the employee, each question requiring the employee to input a response which is recorded as a numerical score; e) Receiving, via the data interface, a numerical score associated with each of the set of questions, the numerical score for each question being assigned a response identifier to associate the numerical value with the question type; f) Calculating, in the processor, the difference between the numerical scores of the question types by averaging the numerical scores associated with desire based questions and the experience based questions thereby providing difference values associated with each of the set of questions; g) Providing, via the data interface, to a user, output data including the difference values associated with each of the set of questions.

In accordance with a tenth aspect, there is provided a computing device such as a webserver for evaluation of company performance using a selection of questions. The computing device may include: a processor for processing digital signals; a memory device for storing digital data including a computer program code, the memory device being configured to be accessible by the processor; a data interface for receiving and sending digital data, the data interface being configured to be to be accessible by the processor; an associated database for storing and retrieving employee data, company data, assessment data and evaluation data, the database being configured to be accessible by the processor.

The processor may be controlled by the computer program code to carry out one or more of the following actions or steps: receive via the data interface employee data; associate the employee data with the assessment data, to determine the selection of questions; provide via the data interface the selection of questions to the employee, the selection of questions including at least one desire based question and at least one experience based question; record, in the database, responses to the selection of questions to provide the evaluation data, the responses being numerical scores; processing the evaluation data by determining a difference value between the numerical scores assigned to the at least one desire based question and the at least one experience based question; and providing or displaying the difference value via the data interface.

### BRIEF DESCRIPTION OF THE FIGURES

The invention is described, by way of non-limiting example only, by reference to the accompanying figures, in which;

FIG. 1 illustrates a schematic view of a computer system;

FIG. 2 illustrates a schematic view server based system incorporating the computer system;

FIG. 3 illustrates an example of a company hierarchy showing tier values or codes assigned to each layer in the company hierarchy;

FIGS. 4a to 4e provide example question sets for the performance categories and performance driver subcategories;

FIG. 5 illustrates an example method preformed by the computer system;

FIG. 6 illustrates another example method preformed by the computer system;

FIG. 7 illustrates another example method preformed by the computer system;

FIG. 8 illustrates an example of operating the computer system to conduct the method;

FIG. 9 illustrates an example output in the form of a report including a graph an tabulated data;

FIG. 10 illustrates an example output in the form of a wheel graph;

FIG. 11 illustrates another example output of the method in the form of a wheel graph showing consolidated results;

FIGS. 12a to 12d illustrates another example outputs in the form of bar charts showing a gap or discrepancy value;

FIG. 13 illustrates another example output of the method in the form of a bar chart;

FIG. 14 illustrates another example output of the method in the form of a report having wheel graph and tabulated results;

FIG. 15 illustrates another example output of the method in the form of a report showing the response rates for the assessment; and

FIG. 16 illustrates an example comparative output results for a senior executive team (SE) member type and middle management (MM) member type.

### DETAILED DESCRIPTION

### The Computing System

The following example and forms, given by way of example only, are described in order to provide a more precise understanding of the subject matter of a preferred example or example methods and computer systems. In the figures, incorporated to illustrate features of an example form, like reference numerals may be used to identify like parts.

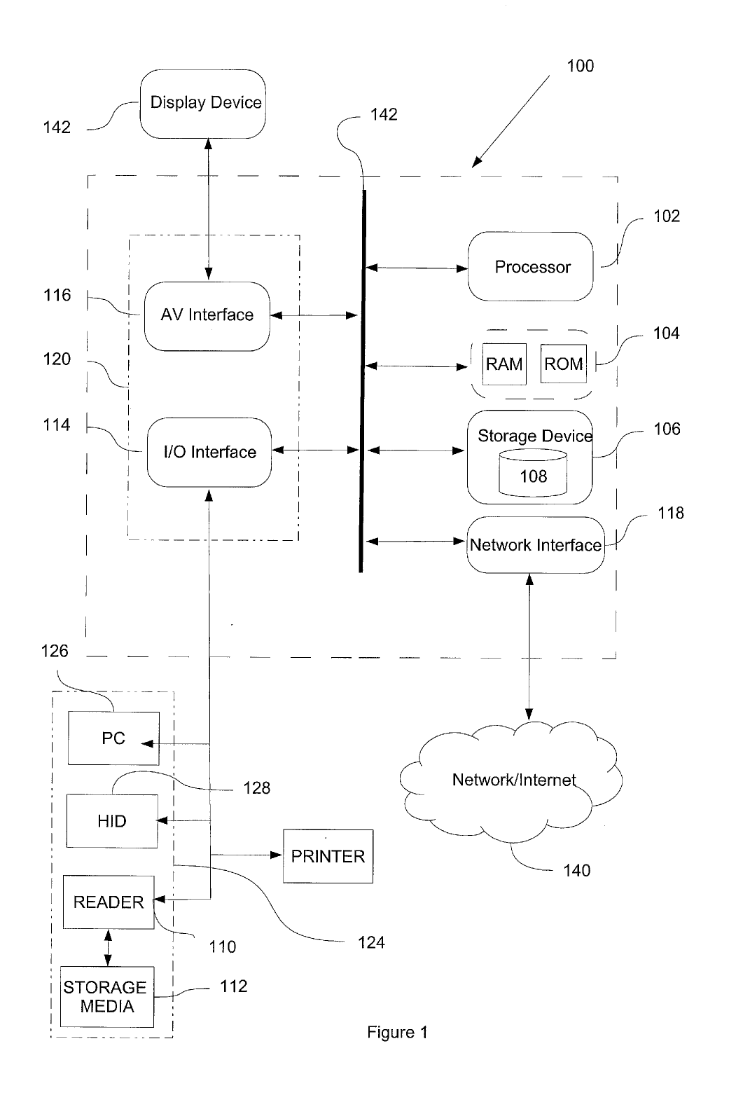

Referring to FIG. 1, there is shown a processing system in the form of a computing device or system 100 on which the various example methods and computer systems described herein may be implemented. For example, the steps of the methods described herein for determining the performance of an organisation may be implemented utilising computer program code instructions executable by the computing system 100.

Turning to the computing system 100 in more detail, the computing system 100 generally includes at least one processor 102, or processing unit or plurality of processors, memory 104, a storage device 106 and at least one data communication input/output (I/O) interface device 120 which is shown in this example to include an input/output (I/O) interface 114, an audio visual (AV) interface 116 and a network interface 118.

Each of the processor 102, the memory 104, the storage device 106, the input/output (I/O) interface 114, the audio visual (AV) interface 116 and the network interface 118 are electrically associated or coupled to one another by a bus system 122. The bus subsystem 122 may offer parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like.

The processor 102 may be a reduced instruction set computer (RISC) or complex instruction set computer (CISC) processor or the like. The processor 102 could include more than one distinct processing device, for example, to handle different functions within the processing system 100.

The memory 104 may include any suitable form of memory device, for example, volatile or non-volatile memory, solid state storage devices, magnetic devices, etc. The memory 104 may include either RAM or ROM or a combination of RAM and ROM and the a storage device 106 may include a magnetic disk hard drive or a solid state disk drive on which a database 108 may be stored.

The input/output (I/O) interface 114 is configured to transmit and receive data from a series of periphery devices 124. The periphery devices 124 may include personal computing device (PC) 126, a human input device (HID) 128 such as a keyboard, mouse, pen or touch screen and a storage media reader 110. The I/O interface 114 may also comprise a computer to computer interface, such as a Recommended Standard 232 (RS-232) interface, for interfacing the computing system 100 with the personal computer (PC) device 126. The periphery devices 124 may also include a printer for displaying data is a report generated the computer code executed by the example computer system 100 described herein.

The storage media reader 110 may be in communication with or connected to storage media 112 on which the computer code which may operate the method is stored. The reader 110 is configured for reading the computer program code instructions from computer program code storage media 112. The storage media 112 may be optical media such as CD-ROM disks, magnetic media such as floppy disks and tape cassettes or flash media such as USB memory sticks.

The computing system 100 may also include a network interface 118 for communicating with one or more computer networks 140. The network 180 may be a wired network, such as a wired Ethernet™ network or a wireless network, such as a Bluetooth™ network or IEEE 802.1 1 network. The network 180 may be a local area network (LAN), such as a home or office computer network, or a wide area network (WAN), such as the Internet or private WAN.

The AV interface 116 may be used for conveying video signals to a display device 142. The display device 142 may be any suitable device such as a liquid crystal display (LCD), cathode-ray tube (CRT) or similar display device. The display device 142 may be utilised to display a graphical user interface (GUI) for the operation and reporting of results such as performance indexes which are generated from the assessment method 400 further described below.

Prior to or during operation of the method described herein the computer program code instructions may be loaded into the storage device 106 from the storage media 1122 using the storage medium reader 110 or from the network 140 using network interface 118.

An example form operation may be as follows: during the bootstrap phase, an operating system and one or more software applications are loaded from the storage device 118 into the memory 104. During the fetch-decode-execute cycle, the processor 102 fetches computer program code instructions from memory 104, decodes the instructions into machine code, executes the instructions and stores one or more intermediate results in the memory 104. In this manner, the instructions stored in the memory 104, when retrieved and executed by the processor 102, may configure the computing system 100 as a special-purpose machine that may perform the methods and associated functionally described herein.

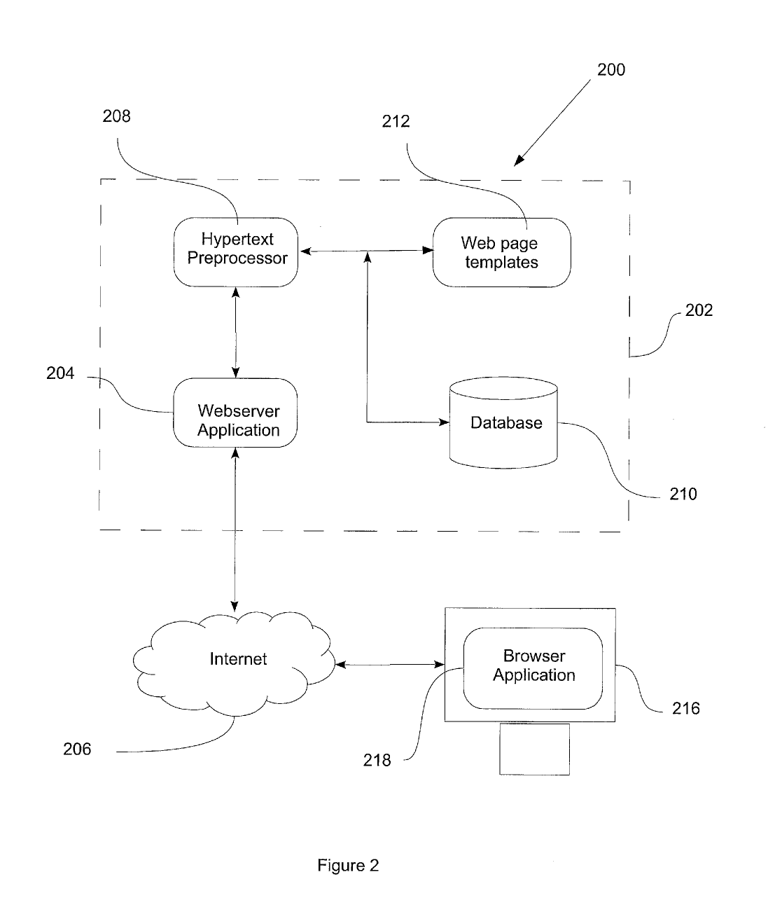

It should be appreciated that the computing system 100 may be any form of terminal, server, specialised hardware, or the like. In particular, the functions, methods and processes described herein may be implemented using a stand-alone form of the computing system 100, or in alternative applications, the functions, methods and processes described herein may be implemented using a web-based client-server architecture as is further detailed below with reference to FIG. 2.

### An Example Server System

Referring now to FIG. 2, the computing system 100 may take on different example forms depending on the application, such as, and as will be described in further detail below, a web server system 200, a client computing device 300, a client computing device 300 in communication with the web server system 200 or the like.

The web server system 200 includes a web server 202, which may include a computing system or device 100 similar to that described above for serving web pages to one or more client computing devices 204 over the Internet 206. In this example, the web server 202 may be provided with a web server application 204 for receiving requests, such as File Transfer Protocol (FTP) and Hypertext Transfer Protocol (HTTP) requests, and serving hypertext web pages or files in response. The web server application 204 may be, for example the Apache™ or the Microsoft™ IIS HTTP server.

The web server 202 may also be provided with a hypertext preprocessor 208 for processing one or more web page templates 212 and data from one or more databases 210 to generate hypertext web pages. The hypertext preprocessor may, for example, be the PHP: Hypertext Preprocessor (PHP) or Microsoft Asp™ hypertext preprocessor. The web server 202 may also provided with web page templates 212, such as one or more PHP or ASP files.

Upon receiving a request from the web server application 202, the hypertext preprocessor 208 is operable to retrieve a web page template, from the web page templates 212, and execute any dynamic content therein, including updating or loading information from the one or more databases 210, to compose a hypertext web page. The composed hypertext web page may comprise client side code, such as Javascript, for Document Object Model (DOM) manipulating, asynchronous HTTP requests and the like.

The database 210 may be configured for storing client or user data such as company name, company structure, employee name, employee type or tier level for use in methods which are described below. The database 210 may also be used to temporality store or permanently store client, member data and responses to the assessments which are further detailed below. For example, the database 210 may be populated with company, employee data and assessment type data. When users such employees as undertake the assessments, which are further detail below, the database 210 may be populated by the responses and numeral scores of the assessments. The method described below is particularly suited to large company assessments and the database system may need to be configured to handle large dataset, for example, assessment data collection from 10,000 employees.

The member may access the server 202 via client computer devices 218. The client computer device 218 may be remotely located from the webserver 202. For example, the client computing devices may be located within a company whereas the server 202 may be located elsewhere such as a secure data facility. To access the server 202, the client computing devices 216 are provided with a browser application 216, such as the Mozilla Firefox™ or Microsoft Internet Explorer™ browser applications. The browser application 226 requests hypertext web pages from the web server 202 and renders the hypertext web pages on a display device such as display device 142. The users may be presented with an email message which directs them the remotely login and access the server which operates the assessment methods as are further detailed below.

It is noted that other network and communication architectures may be available to execute the assessment methods as described below. For example, the assessment methods 400, 500, 600, 700 described herein may be implemented by a network comprising a data network other than a packet switched data network, such as by a data network implementing a propriety transmission protocol. In addition, the method such as the assessment methods described herein may be implemented by a stand-alone computing device. In particular, analysis and reporting of the data which may be undertaken post data collection from remote clients, such as members, may be implemented by a stand-alone computing device. This standalone device may include software configured to calculate the discrepancy analysis, performance indexes and generated graphically reporting graphs which may be interactively modified by a user such as an administrator by a GUI.

### The Assessment Method Overview

Before describing the method steps in detail, a brief overview of the method, the theory behind the method, the data structures and the data relationships is provided. In the broadest sense, the assessment methods described herein present a series of questions to members an organisation. The members may be employees of the organisation and the organisation may be a company.

The members input a numerical value in response the series of questions. The numerical score data is then recorded for each of the members in a database. Once the assessment period has elapsed or when enough members have completed the assessment, the recorded numerical score data is processed by the computer system 100 to make a determination or assessment of the performance of the organisation company, company management or other assessable entity of interest.

In particular, the members are asked a series or sequence of questions, known herein as performance criteria questions, which relate to the performance or function of the organisation or to the performance of other members of the organisation such as managers and leaders of the organisation. Each question includes a base statement or base question related to a single performance driver.

The base statement is presented to the member as at least two separate questions by using different preambles to the base statement. These two questions ask the base statement in contrasting ways so that the user responds to the base question with two separate responses. This provides two score values for each base statement and allows a difference or discrepancy metric to be determined by calculating the different between the two score values. This value is used to make the determination or quantitative assessment of the company performance.

Taking a simplified example, first question may include the preamble “how often do you experience the” followed by the [base statement] and the second question may have the preamble “how often do you desire the” followed by the [base statement]. This presents to the member a first “desire” based question and a second “experience” based question. It is noted that “desire” may be replaced with “want” and “experience” may be replaced by “receive”. Other contrasting word sets may also be used.

Continuing on with the simplified example, assuming the member provides a numerical score of 75% for the desire based questions and 25% for the experience based questions. The computation system 100 may then be utilised to calculate difference or discrepancy of +50% between these values (i.e difference between what the member desires or want and what the member actually experiences or receives).

Accordingly, for the particular performance driver a discrepancy score or metric may be recorded. This may be repeated for numerous employees and include questions which are related to numerous performance drivers as is further detailed below.

Moreover, as will be further detailed below this discrepancy metric may be associated with member data such as the member type and member tier value. For example, the discrepancy metric may be associated with the type of members such as a workforce member, manager, middle manager or leader. The discrepancy metric may also be associated with further entity relationships of the member such as the member tier value which is related to the position or tier level of the member within organisational structure. This member tier value may categorise a member and any calculated discrepancy metric data by country, by office location and by department (i.e. sales, marketing and development). This allows the calculated discrepancy metric for any given member type and any given member tier value. For example, management member types could be compared from two different member tier values, such as Australia and the USA.

The method described herein, in addition to measuring the discrepancy metric as described above, may also provide or utilise different assessment types for different member types and members having different member tier values. For example, the workforce type members may be provided with a different assessment tasks focussed on the overall organisation or on their immediate management. Specific discrepancy metrics may then be calculated for these assessments in a similar manner to that described above. Similarly, a member type being a manager may be provided with a management assessment type and the discrepancy metric may be calculated for the management assessment type. The workforce and management may also take some common assessment types which are used for overall comparison purposes, such as assessing the overall performance of the organisation.

Before describing the methods in detail, the member data including member types and member tier values, assessment data and related performance criteria questions are further detailed and discussed below.

### Member Data

Referring to Table 1, the member data includes information identifying the member type. For example, the member may be identified as being one of the following member types: workforce (WF), Team leader (TL), middle management (MM) and senior executive (SE).

In the methods described herein the member data, more specifically the member type (i.e. WF, TL, MM and SE) may be used to determine which assessment type and related questions are asked or if members at that level are to be included in the assessment. As is further detailed below, a WF type member may receive a different or altered question set to a MM type member. In addition, the member types may also be used to categorise the results. For example, the results may compare the discrepancy metrics from all the WF type members with the MM type members.

TABLE 1
Member Types and Brief Descriptions

| Member types Code | Member Type Description |
|---|---|
| SE | Senior Exec |
| MM | Middle Management |
| TL | Team leader or supervisor |
| WF | Workforce (no reporting staff) |

The member data may be stored in a database such as database 108 and accessed by the processor 102 during executing of the methods 400, 500 and 600 which are further detailed below.

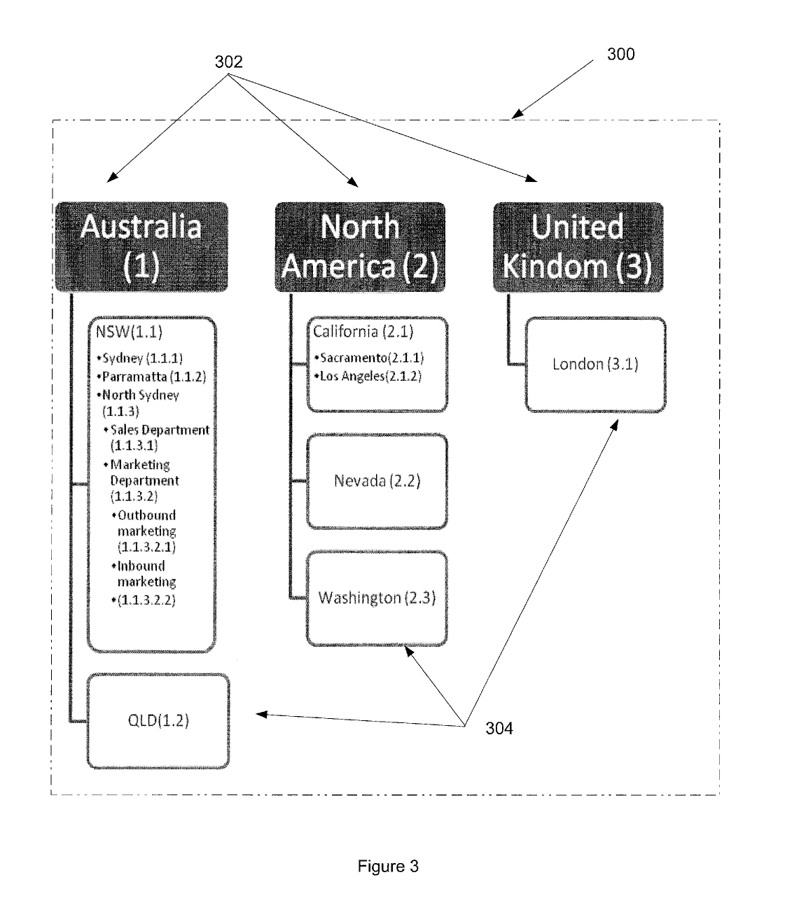

The member data may also include a member tier value. This is a value which relates the member to a particular tier or level within the organisation, for the example the member tier value may the location, function or cost centre of the member. An example of an organisational structure in the form of a company structure is shown in FIG. 3.

### Organisation Structure Data

Referring to FIG. 3, there is shown a company 300 having a number of tiers including two regional locations 302, Australian and the USA indicated as Tier 1 and Tier 2 respectively. Each location has a number of sub-tiers, for example, NSW is 1.1 and QLD is 1.2. The sub-tiers are then further split or categorized into specific office location and then department. For example, 1.1.3 is North Sydney and 1.1.3.2 is marketing at North Sydney.

Each member may be tagged or associated the corresponding company structure which applies to them. For example, particular members may be tagged or identified with member tier value which may be in the form of a code such as [1.1.3.2] being the marketing department in North Sydney.

Accordingly, the member data may further include the member tier value which may then be used to relate the member and their position or tier in the company to a specific assessment type or a series of assessment types are is further detailed below. The member tier may also be used in the processing and analysis of the results data to compare the results data from members having different member tier values or group members having common member tier values.

The member data further including the member tier values may be stored in a database such as database 108 and accessed by the processor 102 during executing of the methods 400, 500 and 600 which are further detailed below.

### Assessment Data and Assessment Types

One of the unique features of the method described herein is that different assessment types may be assigned or used for different member types (i.e. SE, MM, WF) and different member tier values (i.e. 1.2.1 etc). An example of assessment data including assessment types are categorised into a series of layers which are summarised in Table 2 below. Each assessment type is related to one or more of the member types shown in Table 1.

TABLE 2
Assessment Type Matrix-Relating Member Type to Question Sets

| Assess- | | |
|---|---|---|
| ment | | |
| Type- | | Related question set and resultant |
| Layers | Description | Index to Measure |
| 1 | Organisation (ALL) | Organisation |
| 2a | Senior Executive (SE) | Senior Executive Performance |
| | | (Index SEPI) |
| 2b | Middle Management | Middle Management (MMPI) |
| | (MM) | |
| 2c | Team Leader (TL) | Leader Team Performance Index |
| | | (LTPI) |
| 3a | Workforce (WF) | Company Performance Index |
| | | (CPI) |
| 3b | Workforce (WF) | Leader Performance Index |
| | | (LPI) |
| 3c | Workforce (WF) | Team Performance Index |
| | | (TPI) |

Referring to Table 3, the member type and member tier value may be associated with each of the plurality of members. In the below described methods 400, 500 and 600, the member data and assessment data as shown in Table 1 and Table 2, respectively, are processed or associated to link or assign each member with one or more assessment types. Once the assessment types are assigned, the relevant series of performance criteria questions are presented to the member. This linked or associated data may be stored in the database 108 and operated on by the computer system 100 to perform the steps in the below described methods 400, 500 and 600.

TABLE 3
Example Members having a Member Type,
Member Tier Value and Assigned Assessment Type.

| | Member | Member | Assessment |
|---|---|---|---|
| Member | Type | Tier Value | Type |
| David | SE | 1.1 | 2a |
| James | MM | 2.1 | 2b |
| Karthi | TL | 1.1 | 2c |
| Dhana | WF | 1.1.1 | 3a, 3b, 3c |
| Rohit | WF | 1.1.1 | 3a, 3b, 3c |
| Steve | TL | 1.1.2 | 2c |
| John | WF | 1.1.2 | 3a, 3b, 3c |
| Alex | MM | 1.2 | 2b |

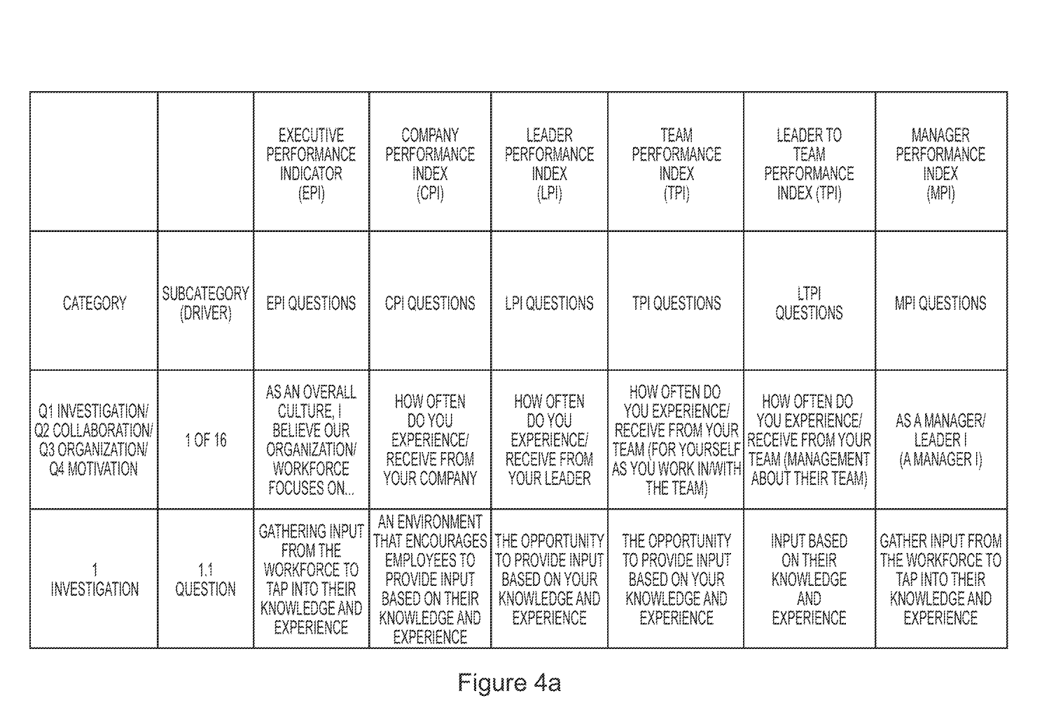

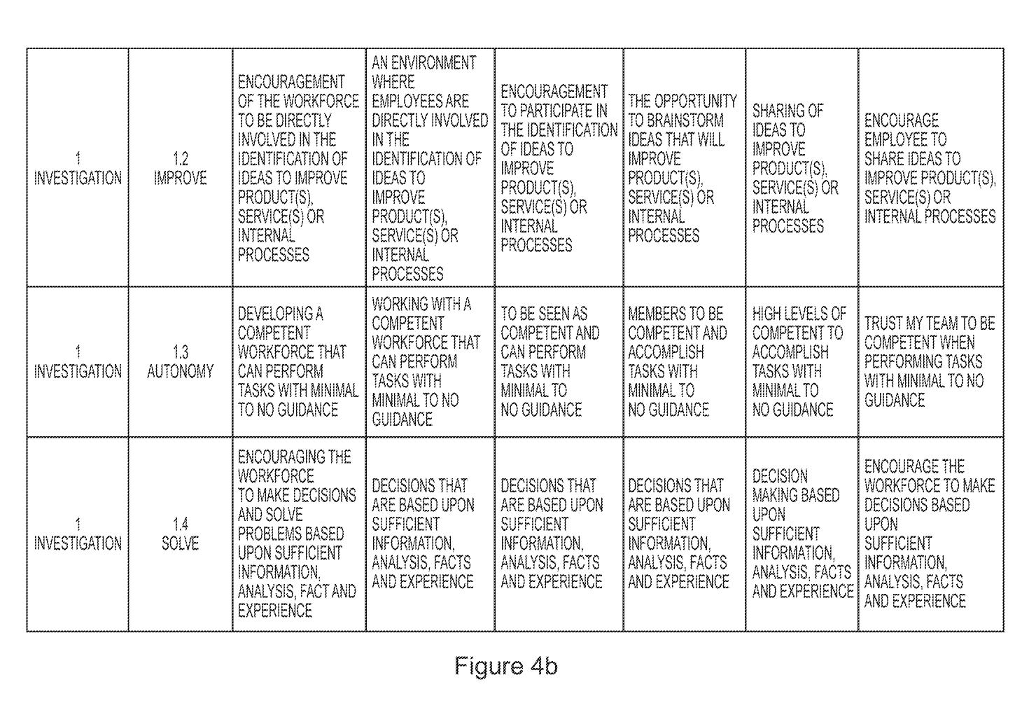

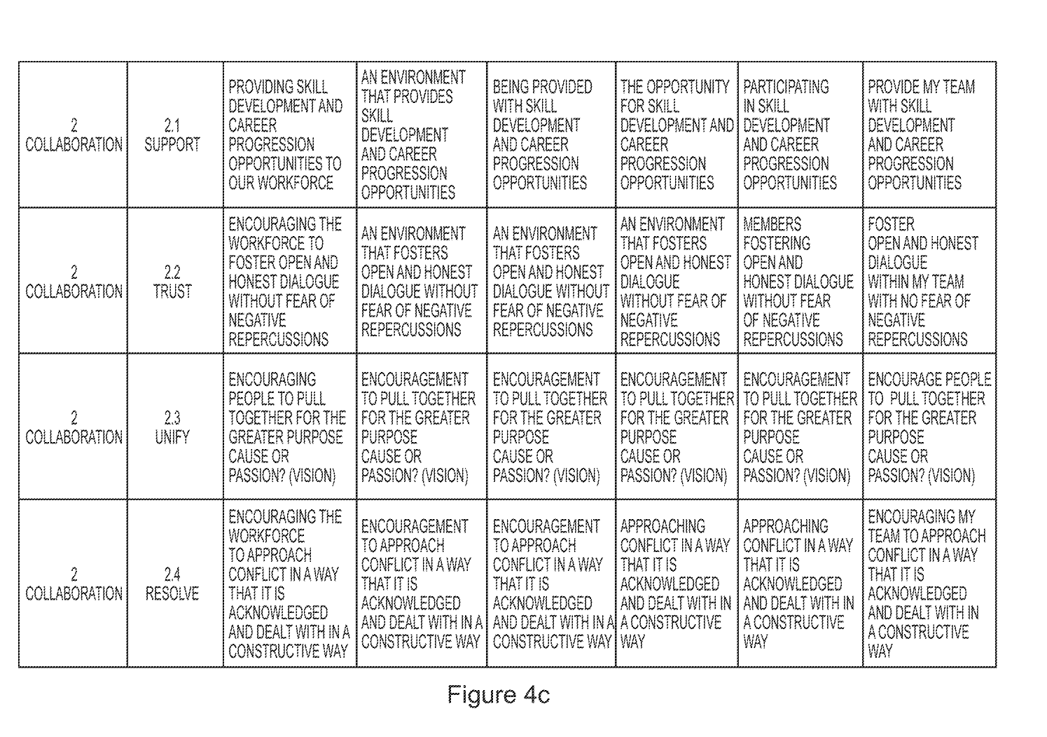

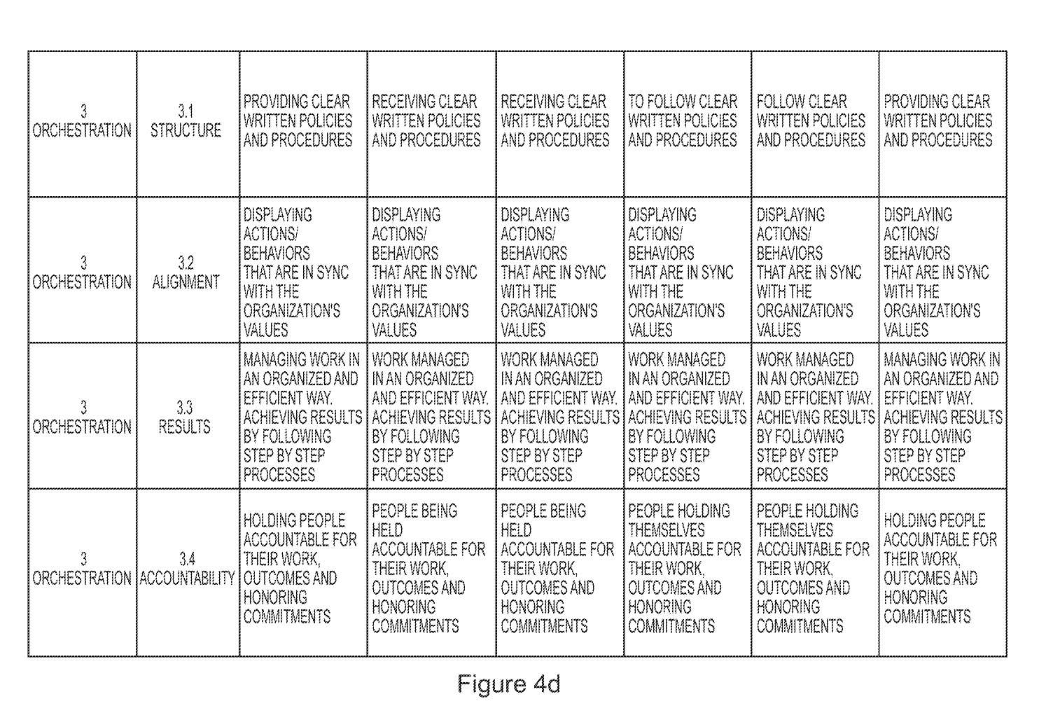

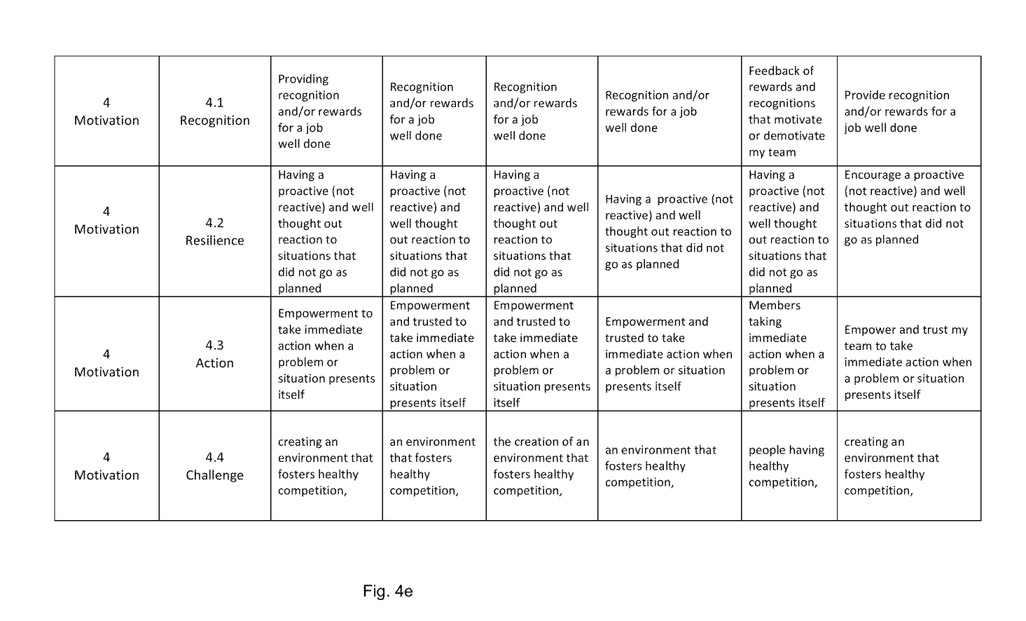

Each assessment type relates to a set of questions which are further detailed below with reference to Table 4 and FIGS. 4a to 4e. For example, if a member is identified as a workforce member, the user may be assigned layer 3a, 3b and 3c assessments. This will then provide or assign the relevant assessment tasks including the relevant questions to that particular member.

The assessment data including the assessment type data may be stored in a database such as database 108 and accessed by the processor 102 during executing of the methods 400, 500 and 600 which are further detailed below.

### Performance Criteria Questions

The example methods provided herein has been developed to provide a consolidated performance metric or index platform which incorporates leadership, temperament, performance and workforce engagement/satisfaction standards. essential business attributes that support the ability of a company, team and/or leader to perform at their highest levels.

Referring to Table 4 below and FIGS. 4a to 4e, the example method provides performance criteria questions which are based on four assessment categories (also known as quadrants) of assessment.

The four categories are:

category 1—investigation;

category 2—collaboration;

category 3—orchestration; and

category 4—motivation.

Each of the four assessment categories includes four subcategories which are identified in this example as subcategories 1.1 to 1.4, subcategories 2.1 to 2.4, subcategories 2.1 to 2.4 and subcategories 4.1 to 4.4. Each of subcategories includes a performance driver or base statement which is utilised for the performance criteria questions. It is noted that the term performance driver may also be referred to as a business driver.

For example, with reference to Table 4, category 1 relates broadly to investigation and the subcategory 1.2 relates to the performance driver of improving. The base statement is “An environment where employees are directly involved in the identification of ideas to improve product(s), service(s) or internal processes”. This statement is then framed as a question to the user by using two different preambles or pre-questions which pose the questions in two different and contrasting ways.

For example, the two preambles may be:
1. “How often do you experience from your company . . . an environment where employees are directly involved in the identification of ideas to improve product(s), service(s) or internal processes”; and
2. How often do you desire from your company . . . an environment where employees are directly involved in the identification of ideas to improve product(s), service(s) or internal processes”

As may be appreciated from the above, the first question relates to the desire of the employee for the post preamble statement and the second question relates to the experience of the employee of the post preamble statement.

In Table 4, example selections of questions from the 3a layer “company performance indicator (CPI)” have been provided. These questions may be used as a basis for assessing the organisation for which the member may work.

TABLE 4
Categories, Subcategories and a Selection Example Questions

| | | | | Assessment Type 3a- |
|---|---|---|---|---|
| | | | | Company performance |
| | Assess- | | | Indicator (CPI) Example |
| | ment | | | Questions: How often |
| Cate- | Descrip- | Sub- | Performance | do you experience/ |
| gory | tion | category | Driver | receive from your company |
| 1 | investi- | 1.1 | Question | an environment that |
| | gation | | | encourages employees to |
| | | | | provide input based on |
| | | | | their knowledge and |
| | | | | experience |
| 1 | investi- | 1.2 | Improve | An environment where |
| | gation | | | employees are directly |
| | | | | involved in the |
| | | | | identification of ideas to |
| | | | | improve product(s), |
| | | | | service(s) or internal |
| | | | | processes |
| 1 | investi- | 1.3 | Autonomy | Working with a |
| | gation | | | competent workforce that |
| | | | | can perform tasks with |
| | | | | minimal to no guidance |
| 1 | investi- | 1.4 | Solve | Decisions that are based |
| | gation | | | upon sufficient |
| | | | | information, analysis, facts |
| | | | | and experience |
| 2 | collabo- | 2.1 | Support | An environment that |
| | ration | | | provides skill development |
| | | | | and career progression |
| | | | | opportunities |
| 2 | collabo- | 2.2 | Trust | An environment that |
| | ration | | | fosters open and honest |
| | | | | dialogue without fear of |
| | | | | negative repercussions |
| 2 | collabo- | 2.3 | Unified | Encouragement to pull |
| | ration | | | together for the greater |
| | | | | purpose cause or |
| | | | | passion? (vision) |
| 2 | collabo- | 2.4 | Resolve | Encouragement to |
| | ration | | | approach conflict in a way |
| | | | | that it is acknowledged |
| | | | | and dealt with in a |
| | | | | constructive way |
| 3 | orches- | 3.1 | Structure | Receiving clear written |
| | tration | | | policies and procedures |
| 3 | orches- | 3.2 | Alignment | Displaying |
| | tration | | | actions/behaviors that are |
| | | | | in sync with the |
| | | | | organization's values |
| 3 | orches- | 3.3 | Results | Work managed in an |
| | tration | | | organized and efficient |
| | | | | way. Achieving results by |
| | | | | following step by step |
| | | | | processes |
| 3 | orches- | 3.4 | Accountability | People being held |
| | tration | | | accountable for their |
| | | | | work, outcomes and |
| | | | | honouring commitments |
| 4 | moti- | 4.1 | Recognition | Recognition and/or |
| | vation | | | rewards for a job |
| | | | | well done |
| 4 | moti- | 4.2 | Resilience | Having a proactive (not |
| | vation | | | reactive) and well thought |
| | | | | out reaction to situations |
| | | | | that did not go as planned |
| 4 | moti- | 4.3 | Action | Empowerment and |
| | vation | | | trusted to take immediate |
| | | | | action when a problem or |
| | | | | situation presents itself |
| 4 | moti- | 4.4 | Challenge | an environment that |
| | vation | | | fosters healthy |
| | | | | competition, |

Other performance criteria questions may also be selected depending on the assigned assessment type. Examples of other question sets are provide in FIGS. 4a to 4c and these may include the Executive Performance Indicator (EPI) question set, Company Performance Index (CPI) question set, Leader Performance Index (LPI) question set, Team Performance Index (TPI) question set, Leader to Team Performance Index (LTPI) question set and the Manager Performance Index (MPI).

These questions are linked or utilised with one or more of the assessment types (1, 2a, 2b, 2c, 3a, 3b, 3c) as have been described above. For example, the CPI questions are used for assessment type 3a and LTPI question set is used for assessment type 2c.

The performance criteria questions are may be stored in a database such as database 108 and accessed by the processor 102 during executing of the methods 400, 500 and 600 which are further detailed below. The performance criteria questions may form part of or be linked to the assessment data or be stored as a separate data set.

### Theory Behind the Questions

### Category 1: Investigation

It has been identified that people, leaders and companies that promote high levels of INVESTIGATION. These people, leaders and companies actively identify opportunities and obstacles that advance products or services, Makes quantifiable improvements, and quality decisions by investigating many options by tapping into the knowledge and skills of the workforce Trusts the competence of the workforce to solve problems and evolve products, services and/or processes.

The benefits of focusing on INVESTIGATION drivers result in the following: For the Company: The Company develops and sustains a highly competent workforce, trusted for their knowledge, skills and innovative ideas. The workforce is actively involved in providing feedback in areas in which they have direct experience and knowledge, these insights are used to improve the way the business operates, customers are served and/or products and services are brought to market.

Benefits for the Leader: The leader empowers team members to work independently, encouraging the workforce to identify obstacles that inhibit or impede progress. The leader focuses on empowering his/her team members to make decisions on their own and are trusted to independently accomplish tasks.

Benefits for the Team: The team is knowledgeable, competent and hard working. Team members find it easier to accomplish tasks independently rather than collaboratively and prefer to communicate only when necessary. Their primary focus is producing high quality products and/or services and making ongoing improvements.

As shown in Table 4, in category 1, the key performance drivers around INVESTIGATION are: Category 1.1—Question: The workforce is encouraged and expected to contribute their knowledge and experience and to question existing standards and norms that may be blocking progress; Category 2.2—Improve: The workforce is encourage to share ideas and suggestions and to seek feedback from the workforce and/or customers in order to improve products, services or processes; Category 2.3—Autonomy: The workforce is trusted to make decisions and offered appropriate levels of autonomy by providing time to work alone; Category 2.4 Solve: The workforce is considered a valuable resource beyond accomplishing tasks. They are seen as an integral part of solving problems, and encouraged to make decisions based upon sound analysis, facts, and experience.

### Category 2: Collaboration

It has been identified that People, leaders and companies that promote high levels of COLLABORATION. These people, leaders and companies activity cultivate and manage interpersonal relationships; consistently displays collegiality, honesty and respect and Encourages and supports the development of the workforce.

Benefits of focusing on COLLABORATIVE drivers result in the following: For the Company: The Company places a high priority on looking after the workforce and decisions are made with individuals in mind High levels of respect are developed through connecting and caring for one another and trust is build by considering the needs and feelings of all involved; For the Leader: The leader values and appreciates individual views and opinions and encourages everyone to display a high level of commitment to each other. The leader focuses on developing the workforce, building team unity and working in collaboration with one another; For the Team: There is a sense of unity in which team members are encouraged to grow and develop. Conflicts and misunderstandings are defused and resolved quickly through collaboration, patience and an appreciation for one another. Their primary focus is on building trust and working in a harmonious environment.

As shown in Table 4, Category 2, the key performance drivers around COLLABORATION are: Category 2.1 Support: The workforce is encouraged to professionally and personally develop beyond their current responsibilities and job role and receive appropriate levels of feedback; Category 2.2 Trust: The workforce experiences an environment of open honest communication that leads to high levels of trust and respect; Category 2.3 Unify: The workforce experiences high levels of collaboration and teamwork when accomplishing tasks; and category 2.4 Resolve: Conflict is viewed as a positive rather than a negative and differences of opinions are addressed and resolved in a manner that allows for professional growth and constructive outcome.

### Category 3: Orchestration

It has been identified that people, leaders and companies that promote high levels of ORCHESTRATION. These people hold the workforce accountable through clear priorities and job requirements; achieves results by setting and following policies and procedures; displays commitment by promoting and supporting the values of the organization.

Benefits of focusing on ORCHESTRATION drivers result in the following: For the Company: The Company provides the workforce with clear directions through set goals and priorities. A highly structured environment is set, timely task completion is expected and results are achieved by following step-by-step processes. For the Leader: The leader relies on systems and processes to produce results. Common goals and priorities are clarified and clearly communicated. The leader focuses on monitoring task completion to ensure time lines are adhered to and work is completed in a structured way. For the Team: The team is loyal and dedicated to achieving set outcomes. They display high levels of accountability and are clear on the processes that allow them to perform to the expected standard. Their primary focus is following a step-by-step format to ensure tasks are completed on time.

As shown in Table 4, Category 3, the key performance drivers around ORCHESTRATION are: Category 3.1 Structure: Ambiguity and errors are reduced through clear priorities, roles and structures that are consistently adhered to; Category 3.2 Alignment: Company values are established, clearly communicated and drive the desired mindset and actions that will have a positive impact on the culture; Category 3.3 Results: Results are achieved by following a step-by-step processes and working in an structured and efficient manner; and Category 3.4 Accountability: The workforce has clearly communicated expectations and priorities and are held accountable for their work.

### Category 4—Motivation

It has been found that people, leaders and companies that promote high levels of MOTIVATION. These people display energy, willingness and confidence to take action when required; provide feedback and recondition, and promote a fluid work environment; display persistence and determination to move forward even in challenging times.

Benefits of focusing on MOTIVATION drivers result in the following: For the Company: The Company is highly resilient and willing to take risks where others hold back. Individuals are empowered to make decisions, take action, and respond quickly thriving in ambiguity and change to drive a continuous evolving environment. For the Leader: The leader focuses on the present moment and responds quickly to change, by overcoming obstacles and difficulties as they arise. The leader provides feedback, freedom and a ‘can do’ attitude that allows his or her team to make achieve outcomes in their own unique way. For the Team: When completing tasks and solving problems the team has high levels of flexibility, energy and motivation. They provide immediate feedback, handle setbacks and are seen as highly resilient. Their primary focus is enjoying the work environment, moving at a quick pace and taking action without a fear of failure.

As shown in Table 4, Category 4, The key performance drivers around MOTIVATION are: Category 4.1 Recognition: The workforce is provide and encouraged to celebrate successes and to . . . ; Category 4.2 Resilience: The workforce has a ‘can do’ attitude and high levels of resiliency even in challenging times; Category 4.3 Action: When problems/situations present themselves the workforce is empowered to make quick decisions, and take immediate action; and Category 4.4 Challenge: Workforce is proved with the opportunity to be creative in their position, and healthy competition is fostered.

### The Method and Computer System

The methods and the computer systems which are configured by a computer program to operate or execute the method steps are now described. The methods utilises data sets including the member data, which includes the member type and the member tier value, and the assessment data which includes assessment types and performance category question data which have been described in detail above.

### Example 1

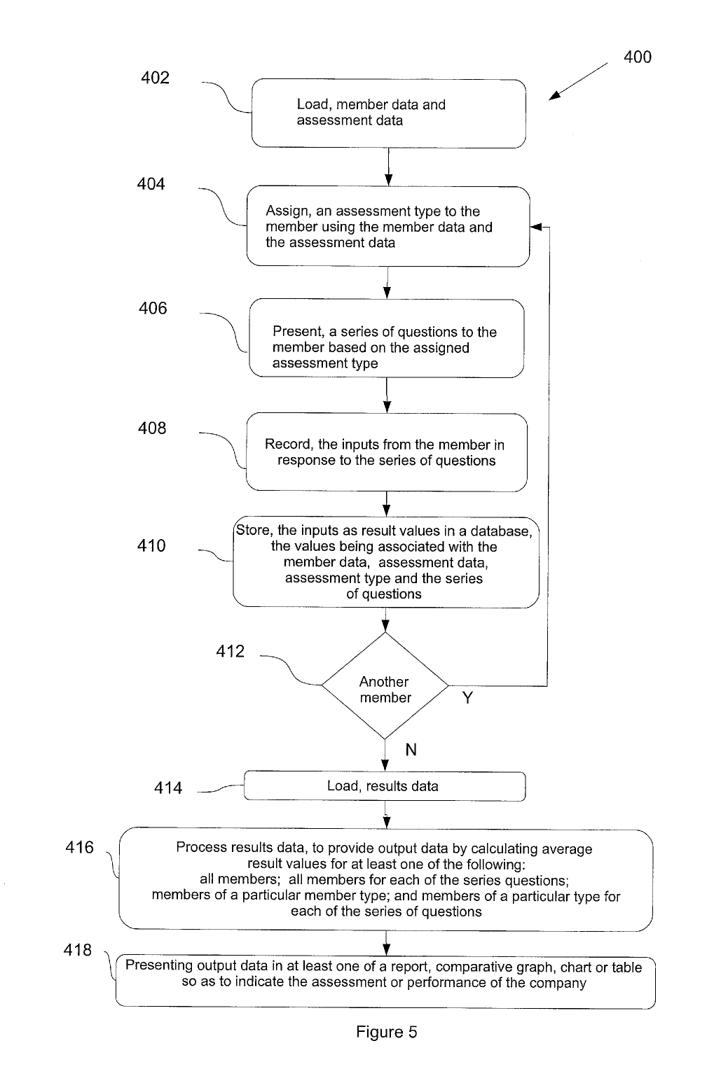

Referring to FIG. 5, there is shown a method 400 executable by the computer system 100, or the server based system 200 having a server 202 which may be in the form of the computer system 100, for assessing the performance of an organisation in relation to a series of performance criteria questions presented to a plurality of members of the organisation.

The organisation may be a company and the members may be employees of the company. As is further detailed below, the company may be assessed in its entirety or sub-entities of the company may be assessed.

The method 400 includes, at step 402 loading in memory 104, member type data and assessment type data. The member type data may include data to relate the member to a type of member such as the member being from the workforce (WF), executive (SE), management (MM) or a team leader (TL). The member type data may also include member tier value data to relate the member to an organisational tier value (i.e. 1.1.2.1) including at least one of location and department. Examples of member type data are shown in Table 1.

The assessment type data may include assessment type identifiers which link to the member type data. An example of the assessment type data is shown in Table 2 and the linking of the assessment type, employee type and tier value is shown in Table 3. The assessment type data may include the performance category questions or be linked with the corresponding performance category questions such as those shown in FIGS. 4a to 4c.

Typically, the database 108 or 112 is loaded with the, member type data, assessment type data and other relevant company data to allow the computer system, as configured by the computer program, to identify each member and assign or associate the member with a member type, tier within the company and assessment type.

The method 400, further includes at step 404, assigning, in the processor 102, an assessment type to each of the plurality of members using the employee type data and the assessment type data. The assigning may include the computer system 100 as configured by the computer program, to conduct lookup and related data comparison operations.

At step 406, the computer system as configured by the computer program, is configured to send, via an interface 118 or 120, question data including a selection of the series of performance criteria questions to each of the plurality of members. The questions may be similar to the example questions shown FIGS. 4a to 4e. These questions may be stored on the database 108 or 112. The interface may output to a local display device 142 or in the case of a server based system 200, the display may be to a web browser 218 of a remote client terminal accessing the server 202. The questions are then displayed or presented to each of the plurality of members.

The selection of the performance criteria questions is based on the assigned assessment type (1, 2a, 2b, 2c, 3a, 3, 3c) such that each of the plurality of members receives a specific assessment. For example, a workforce employee (WF) type may receive a different assessment type to a senior executive employee (SE). Similarly, an employee from a tier level (e.g. 1) such as Australia may receive a different assessment to an employee with a tier level such as the USA (e.g. 2).

The member then scores the selection of the series of performance criteria questions by providing a numerical score for each the series of performance criteria questions. The member may input the score data via a HID 128, for example, by a mouse selection or keystroke displayed on the display device 142. Where the computer system is incorporated in a server based system 200, the member may access the server 202 running the program via the client terminal 216 browser application 218. A graphical user interface may be used to display and record the scores to the questions. As is further detailed below numerical scores for may be inputted in the form of: Never=0%; Infrequently=about 25% of the time; Sometimes=about 50% of the time; Frequently=about 75% of the time; and Always=95%+ of the time.

At step 408, the computer system as configured by the computer program to record, in memory which may be the memory 104, input scores from each of the plurality of members in response to the selection of the performance criteria questions.

At step 410, the computer system as configured by the computer program to store, in a database 106, 112, the input scores as results value data. The values for each of the selection of the performance criteria questions (i.e. 0%, 25%, 50%, 75%, 95%) are stored so as to be being associated with at least one of the member type data, assessment type data and the series of questions.

At step 412, the methods steps 402 to 410 may be repeated for each of the plurality of members to build a large results value data set. For example, the organisation or company may have 1,000 or 100,000 members which need to complete the assessment. Once the data set has been finalised, for example, by assessing a count of the members who have completed the assessment or by waiting for an assessment time period to elapse, the data set may be loaded into memory 104 at step 414 for analysis and processing.

At step 416, the computer system is configured by the computer program to process, in the processor 102, the results data to provide output data by calculating average result score values for at least one of the following: average of all input scores for the plurality of members; average of input scores for each of the plurality of the performance criteria questions; average of the input scores for each assigned assessment type for the plurality of member. Further details in relation to the processing and averaging arithmetic operations performed by the processor 102 are provided below with reference to Tables 5 and 6.

At step 418, the computer system as configured by the computer program, presents or displays via the interface 118, 120, the output data in at least one of a report, comparative graph, chart, table or list so as to indicate the performance of the organisation in relation to the series of performance criteria questions presented to the plurality of members.

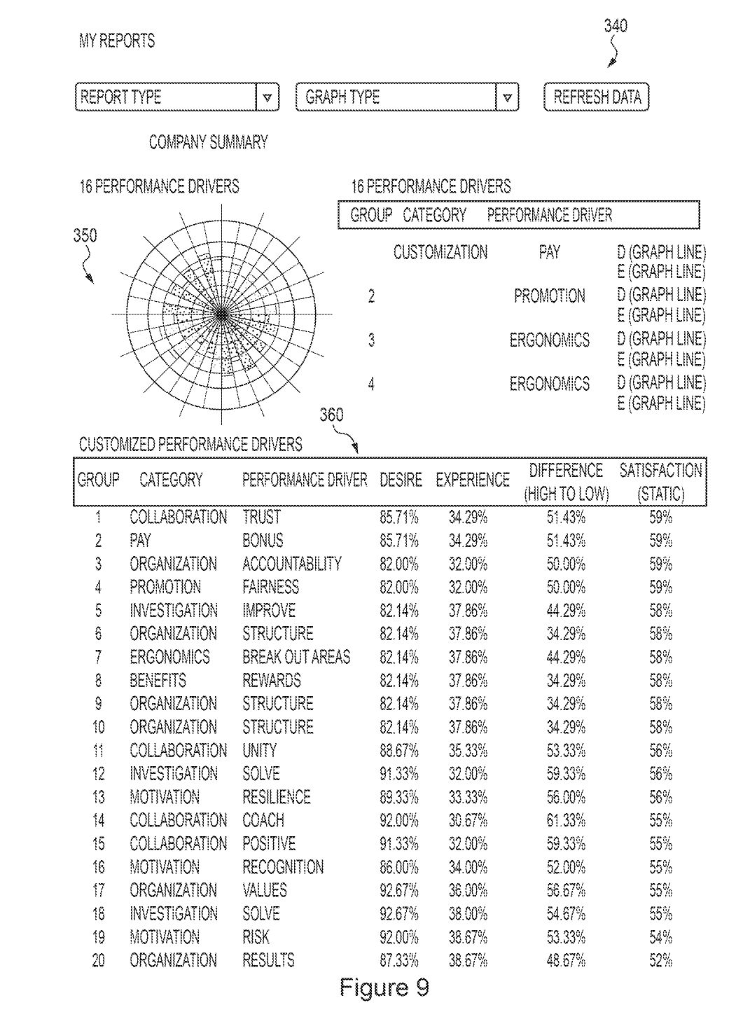

The output data includes the average result score values which may be presented in associated with the subcategory performance criteria questions (1.1 to 4.4) or a consolidated set of the performance criteria questions namely the performance categories (1 to 4). The results or output display may be via a screen, graphical user interface, printed or otherwise communicated to a user either locally or remotely via a network such as the internet. Example outputs are provided below with reference to FIGS. 9 to 16.

In some examples of the method 400, at step 406, the series of performance criteria questions include a set of performance statements, or base statements, and each performance statement is presented to the member in two contrasting ways such that the member provides two input scores for each of the performance statements. These questions may be selected from assessment data which includes information such as that shown in Table 4 above and FIGS. 4a to 4e.

At step 416 of processing, a difference between the two input scores for each of the performance statements is calculated to determine a discrepancy metric for each of the performance statements. Example discrepancy calculations are provided below with reference to Tables 6 and 7.

In some examples of the method 400, at the step 416 of presenting the series of performance criteria questions, a first set of the selection of the series of performance criteria questions are presented to the member at a first time and a second set of the series of performance criteria questions are presented to the member at a second time. The first set includes first questions presented to the member in one of the two contrasting ways and the second set includes second questions presented to the member in the other of the two contrasting ways.

For example, the first set of questions may include only desire based questions and the second set of questions may only include only experience based questions. The first time may be the start date of the assessment or the date of which the member logs into the system and completes the first set of questions of the assigned assessment. The second time may be, for example, an elapsed time of 14 days after the start data of the assessment or 14 days after the member completes the first set of questions. Other elapsed time intervals may also be used ranging from hours and days to weeks and months. The reason for the elapsed time interval is to allow the member to undertake only one set of either the desire based or experience based questions at any one time which assist to focus the mindset of the member. The times may be pre-defined by a system administrator as is further details in relation to method 700 below.

The computer system 100, more specifically the processor 102 as configured by the computer program, monitors the first and second times, elapsed times or pre-defined times so as to automatically present the member with the first and second sets of questions at the first and second times. In practice, this may be accomplished by sending an email to the member to login and begin the assessment based on the first set of the questions at the first time. Then, a further or reminder email may be sent to the member after a predefined period of time has elapsed and the member may log back in and is provided with or allowed to complete the second set of questions. Once the results data is complete, the further processing steps and results steps may be completed as set out above.

In some examples of the method, the member data includes member types including at least a first member type and a second member type, and wherein in the step of processing 416, the discrepancy metric for each of the performance statements is associated with the member types of each of the plurality of members. For example, the first member type may be a workforce member type, an executive member type or a middle manager member type. The second member type may be any other of the member types which are not the first member type. The member types are details in Table 1.

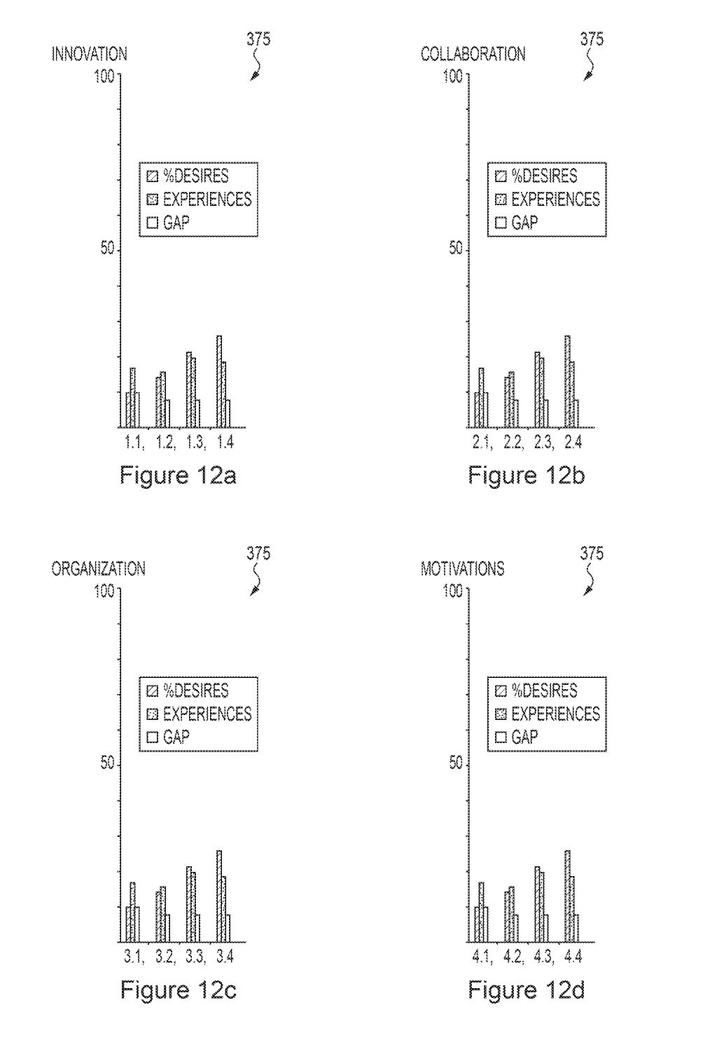

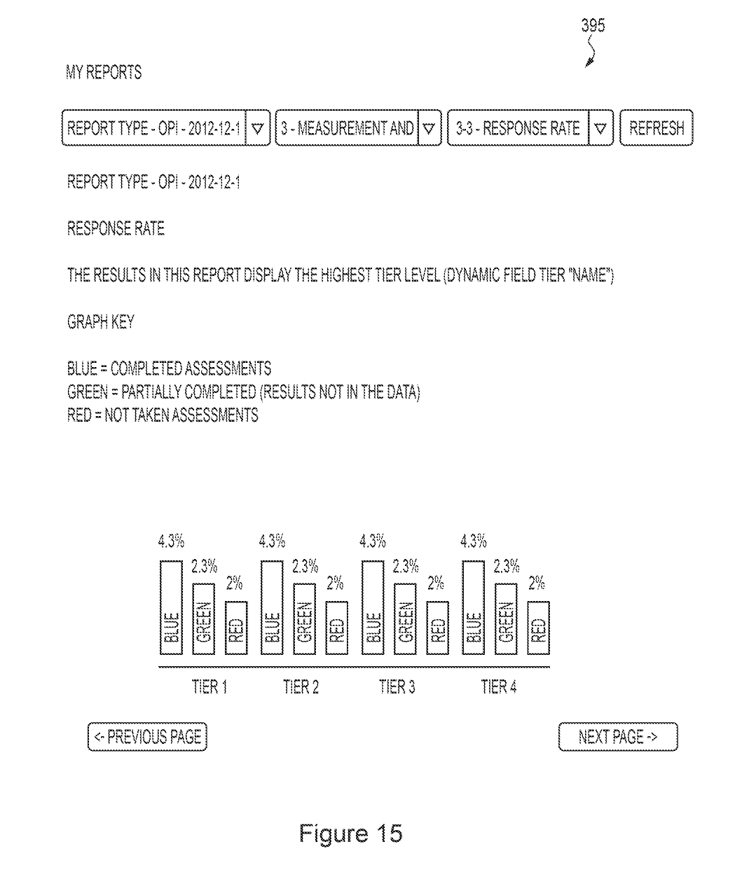

In some examples, in the step of presenting 418, the discrepancy metrics for the first member type are compared to the discrepancy metrics for the second member type in at least one of a comparative chart, table or report. An example of these comparative charts, tables and reports shown in FIGS. 12 and 15.

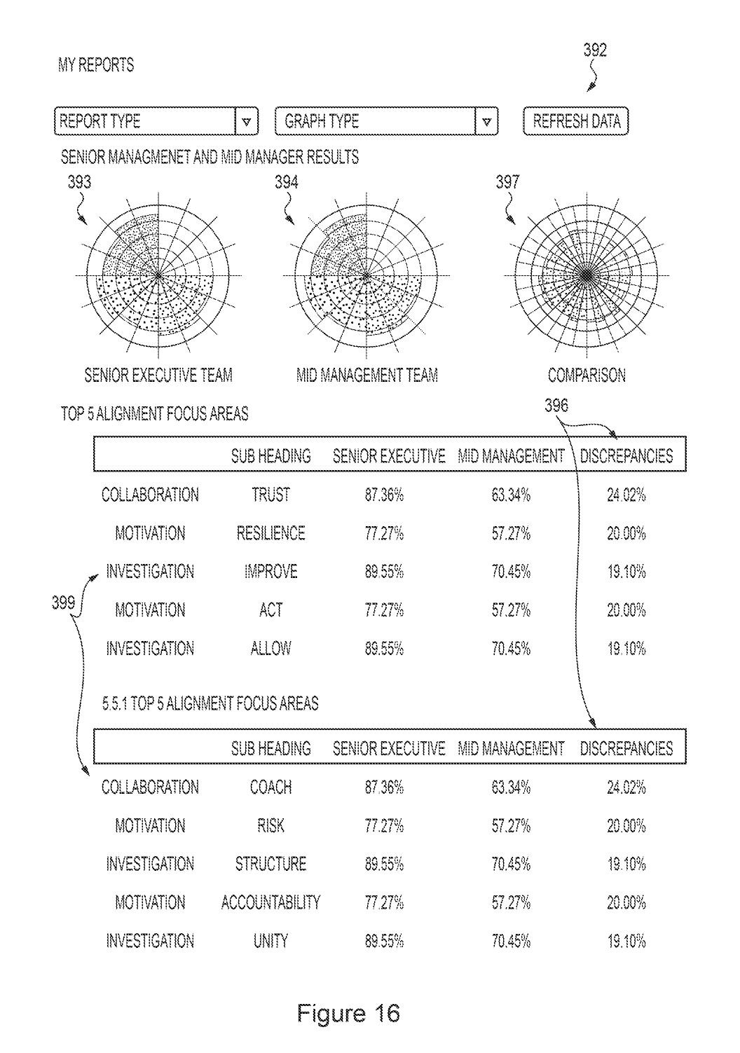

Since the discrepancy metrics have been calculated for the first member type and the second member type a further discrepancy metric may be calculated by determining the difference between the discrepancy metric for the first member type the second member type discrepancy metric for the first member type and the second member type. An example of the further discrepancy metric is shown in FIG. 16. As the result data is associated with each of the member types and the performance drivers, this enables a multitude of comparative type assessment assessments to be made not only between the performance drivers but also between the member types.

In some examples of the method, the performance statements are subcategories of a main set of performance categories. The categories and subcategory data is shown in Table 4. Accordingly, step 416 of processing may include calculation of a consolidated discrepancy metric for each of the performance categories and in step 418 of presenting, the output data includes at least one of displaying the consolidated discrepancy metric for each of the performance categories. An example of the consolidated discrepancy metric is provided in Table 5 below. This consolidated metric provides a useful organisational or company performance index measured against the performance categories.

In some examples of the method 400, at step 416 of processing, the performance statements are ranked according to the value of the discrepancy metric for each of the performance statements and at step 418 of presenting, the output data includes at least one of a table, graph or list which shows the ranked performance statements. An example ranking table is detailed below with reference to FIG. 9.

In some examples of the method 400, the two contrasting ways of presenting the performance statement include presenting each performance statement as a first desire based question and a second experience based question. The discrepancy metric is then determined by subtracting the input score of the second experience based question from the input score of the first desire based question. An example of this type of result is further detailed below with reference to FIG. 9

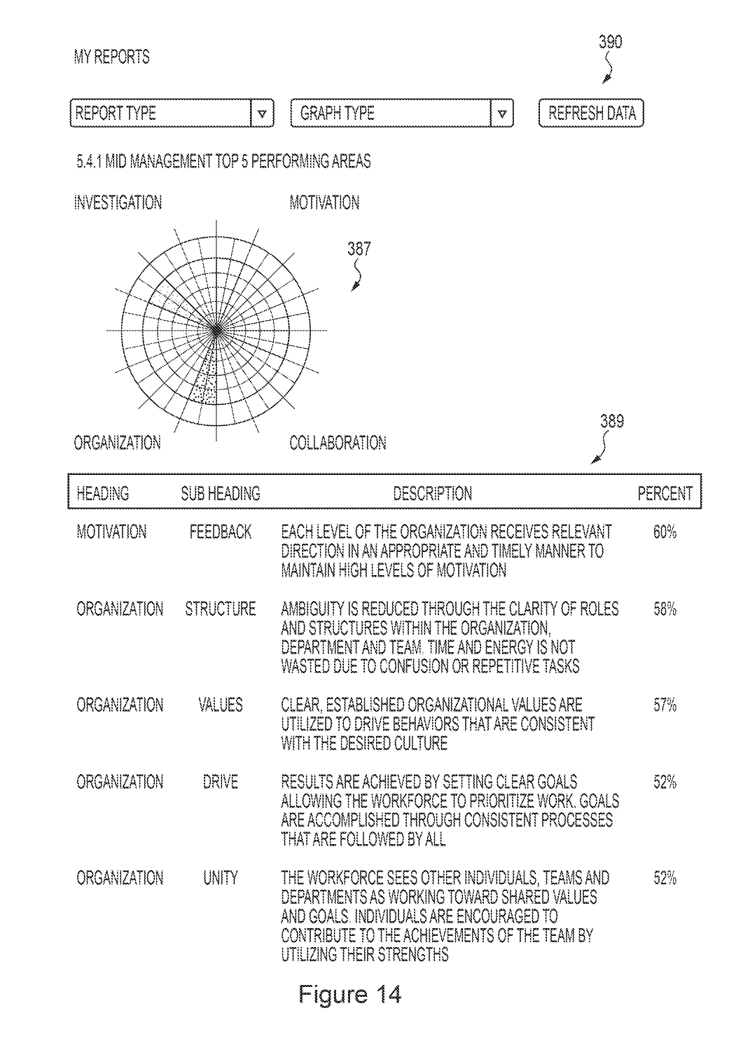

In some examples, where the method 400 has been performed to include the type of member and include a member tier value associated with the member, the output data may be presented at step 418 to display results data associated with at least one of the type of member and the member tier value. An example of this type of result is further detailed below with reference to FIG. 14.

### Example 2

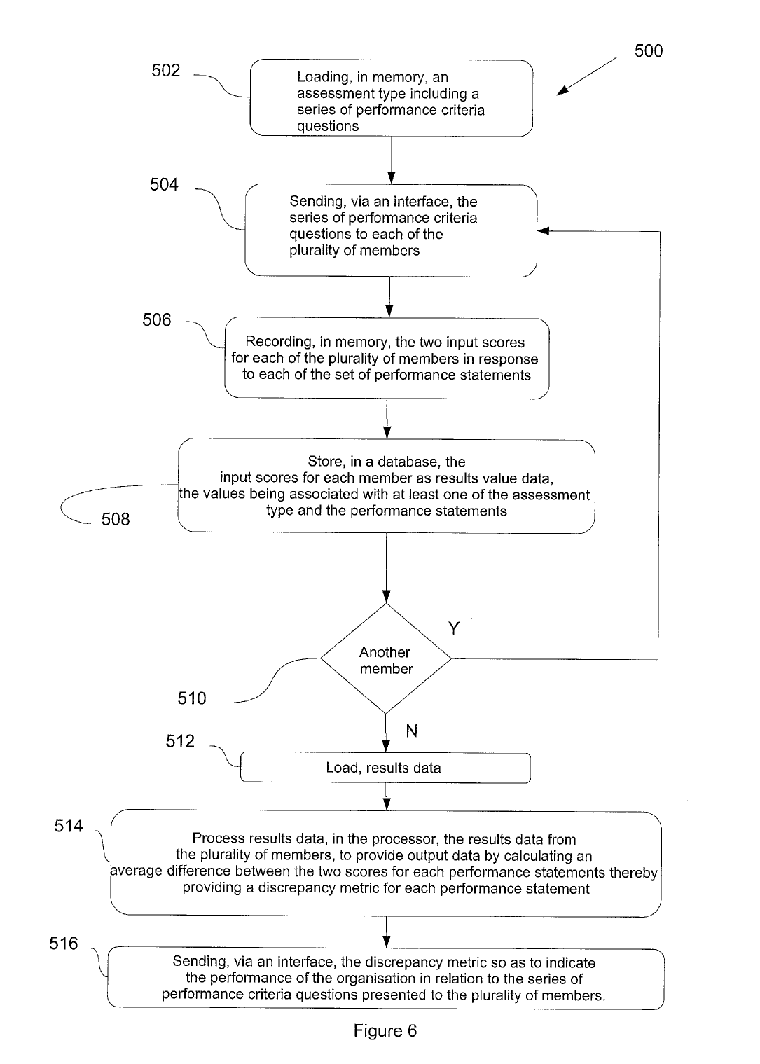

Referring to FIG. 6, there is shown another method 500 executable by the computer system 100 or the server based system 200 for assessing the performance of an organisation in relation to a series of performance criteria questions presented to a plurality of members of the organisation. This method utilises similar data to the first example method detailed above. Accordingly, similar data examples and computer operations are relevant here.

The method 500, including the steps of at step 502 loading, in memory, an assessment type including the series of performance criteria questions. At step 504, presenting or displaying, via the interface 118, 120 the series of performance criteria questions to each of the plurality of members. The series of performance criteria questions including a set of performance statements and each performance statement is presented to each member in two contrasting ways such that the member provides two input scores for each of the performance statements. The questions and performance statements, as referred to as base statement or performance drivers, are further detailed below. These questions may be based on the questions shown in FIGS. 4a to 4c and may be presented to the user at a remote client terminal via the interface.

At step 506, the computer system is configured by the computer program to, recording, in memory, the two input scores for each of the plurality of members in response to each of the set of performance statements and at step 508 the computer system is configured by the computer program to store, in the database, the input scores for each member as results value data, the values being associated with at least one of the assessment type and the performance statements. Examples of the two input scores for a set of performance statements are shown in Tables 5 and 6 below.

At step 510, the methods steps 504 to 508 may be repeated for each of the plurality of members to build a large results value data set. Once the data set has been finalised, for example, by assessing a count of the members who have completed the assessment or by waiting for an assessment time period to elapse, the data set may be loaded at step 512 for analysis and processing.

At step 514, the computer system is configured by the computer program to process, in the processor 102, the results data from the plurality of members, to provide output data by calculating an average difference between the two scores for each performance statements thereby providing a discrepancy metric for each performance statement. Examples of the calculation of the discrepancy metric are further detailed below with reference to Table 5 and 6.

At step 516, the computer system is configured by the computer program, to allow viewing or presenting, via the data output, the discrepancy metric so as to indicate the performance of the organisation in relation to the series of performance criteria questions presented to the plurality of members. Examples of the data output are further detailed below with reference to FIGS. 9 to 15.

In some examples of the method, the computer code may configure the computer system, at processing step 514, to load the results data for the plurality of members; calculate, an average of the first of the two input scores for each of the set of performance statements for the plurality of members to provide a set of first averaged values for each of the performance statements; calculate, an average of the second of the two input scores for each of the set of performance statements for the plurality of members to provide a second set of averaged value for each of the performance statements; and calculate the discrepancy metric by determining the difference between the a set of first averaged values and second set of averaged value thereby providing an average discrepancy metric for each of the performance statements. An example of these averaged discrepancy metrics is described below with reference to Table 6.

In some examples of the method, the computer code may also configure the computer system, at processing step 514, to rank the performance statements according to the value of the averaged discrepancy metric for each of the performance statements, and, in step 516 of displaying, the output data may include at least one of a table, graph or list which shows the ranked performance statements. An example of a output report including ranking is shown in FIG. 9.

In some examples of the method 500, the two contrasting ways of presenting the performance statement include presenting each performance statement as a desire based question and an experience based question. The discrepancy metric is then determined by subtracting the input score of the experience based question from the input score of the desire based question. An example of the results to an assessment including desire based questions and experience based questions is shown in FIG. 9.

In some examples of the method 500, step 504 of presenting, via an interface, the selection of the series of performance criteria questions, the member remotely accesses the computer system and may provide authentication details which are used to assign the selection of questions to the member. This allows members to login to the computer system, which may be a server, and undertake the assessment from any remote location using a remote client computing device.

In some examples of the method 500, the method 500 includes at step 502, loading, in memory, member type data and assessment type data and determining, in the processor, a member type based on the member type data and assigning a specific assessment type to a member by associating the member type with the specific assessment type stored in the assessment type data. At step 504, presenting, via the interface, a selection o the performance statements to each of the plurality of members, the selection being based on the specific assigned assessment type. At step 506 recording, in memory, input scores from each of the plurality of members in response to the selection of the performance statements, at step 508 storing, in the database, the input scores for each member as results value data, the values being associated with at least one of the determined member type, specific assessment type and the selection of performance statements and at step 514, processing the results value data, so as to determine a further average discrepancy metrics associated with at least one of the determined member type, specific assessment type and the selection of performance statements.

### Example 3

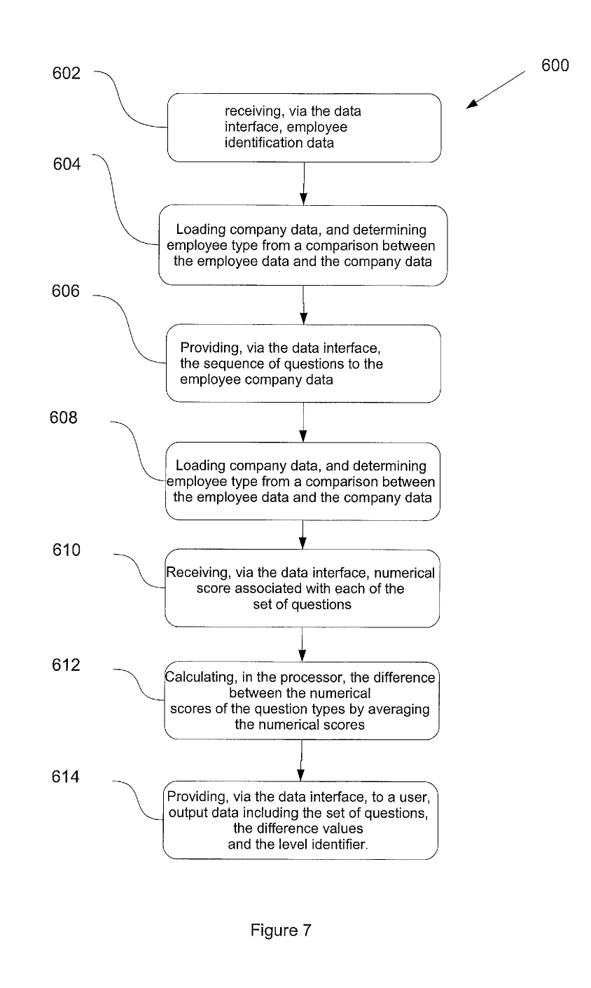

Referring to FIG. 7, there is provided a method 500 for determining a performance index or metric for group of employees within a company structure using a computer system 100 or server system 200 as described above with reference to FIGS. 1 and 2. The computer system 100 including a processor 102, a memory device 104 for storing digital data including a computer program code, the memory device 104 being configured to be accessible by the processor 102; a data interface 120 connected to the processing module and a database 106 or externally connected database 112, configured to be accessible by the processor 102.

The method 600 starts at step 602 where processor 102 is controlled by the computer program code to carry out step 602 of receiving, via the data interface, employee data for an employee in the group. The employee data may include an employee identification number, code or text string.

At step 604, the processor 102 is controlled by the computer program code to accesses, via the storage device 106 or 112, or I/O interface 114, company structure data, loading the company structure data, and processing the employee data and company data to determine a unique identifier for the employee. This involves the processor being controlled by the computer program to compare the employee data, which may include an employee identification number or name, with the company structure data to determine the identifier for the employee.

The identifier may include code either numerical or text which relates the employee to a position in the company such as department, geographic location and employee type such as manager, team member etc. The identifier may also include the employee tier level code such as that describe above i.e. 1.2.1.

The employee data may include the employee name or number, for example, #1234 which when compared with or associated with the company database provides the level identifier code “WF, MM, etc.” (i.e. Employee type: Middle Manager). This code may also be concatenated with the employee code and the tier level to provide a reference string unique to the employee, for example, the identifier for a particular employee may be [1234][MM][1.2.2].

At Step 606, the processor 102 is controlled by the computer program code to access, via the storage device 106 or I/O interface 114, question data, loading the question data and processing the question data to determine a set of questions which are specific to the identifier, the set of questions including a series of question types. Each question type includes at least one desire based question and at least one experience based question.

At step 608, providing, via the data interface, the sequence of questions to the employee, each question requiring the employee to input a response which is recorded as a numerical score. The questions may be provided via the internet to a remote computer or via a locally accesses computing device. Alternatively, the user may login remotely from a remote client computing device to a server, which includes the computing system, to complete the assessment.

At step 610, receiving, via the data interface, numerical score associated with each of the set of questions, the numerical score for each question being assigned a response identifier to associate the numerical value with the question type.

At step 612, calculating, in the processor, the difference between the numerical scores of the question types by averaging the numerical scores associated with desire based questions and the experience based questions thereby providing difference values associated with each of the set of questions.

At step 615, providing, via the data interface, to a user, output data including at least a subset of the set of questions, the difference values and the level identifier. These may include table, bar charts or graphs similar to those shown in FIGS. 9 to 14 as further described below.

The methods 400, 500 and 600 as described above may be operated or controlled with a graphical user interface and may require setup and administration by an administration user. The administration user may need overarching control over the assessment to undertake a series of steps such as assigning the assessment types or providing start and end dates for the assessments. The method 700 as set out below typically is conducted prior to or in conjunction with the methods 400, 500 and 600. The methods 400, 500 and 600 may run as subroutines with method 700 running as a main routine.

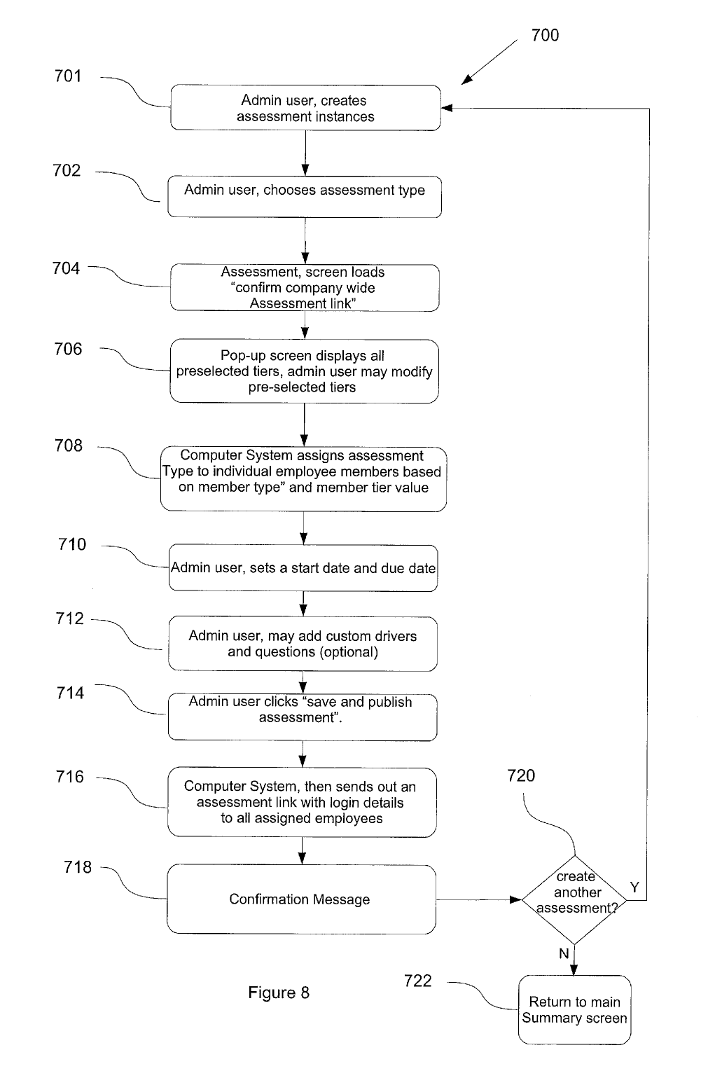

Referring to FIG. 8, there is shown a method 700 for creating an assessment instance at step 701. The method including the steps of, at step, 702, the administration user selects the assessment type, for example, —OPI—organisation performance index.

At step 704, a screen is presented to the administration user to confirm the assessment selection and, at step 706, a further screen is displayed to show the company tiers which are pre-selected. The administration user may then modify this selection, for example, by removing or adding a tier in relation to a particular geographic location.

At step 708, the computer system then assigns the assessment type to individual employees based on the employee data which may include an employee tier value. This step may form part of sub routine methods 400, 500 and 600. Alternately, this step may occur prior to sub routine methods 400, 500 and 600.

At step 710, the administration user sets a start date and end data for the assessment and at step 712, the administration user may add additional drivers and questions to the assessment.

At step 714, the administration user publishes the assessment and saves the assessment to the database of the computer system. At step 716, the computer system then automatically sends out an email link to the assigned employees. These employees then log into the computer system and conduct the assessment as is described in sub routine methods 400, 500 and 600. At step 718, the administration user is provided with a confirmation screen and the option to create another assessment at step 720. If no further assessments are to be created then the administration user is returned to a main summary screen.

Further detailed information is now provided below in relation to the calculations, in particular the discrepancy analysis, undertaken in relation to methods 400, 500, 600 and 700.

### the Discrepancy or Difference Analysis

As has been described above, the method provided herein provides a member with a series of questions which related to a series of company assessment performance drivers. In the examples, discussed above, there may be four categories of questions (category 1—investigation, category 2—collaboration; category 3—orchestration; and category 4—motivation). Each these four categories then have four subcategories each relate to a performance driver base question. Accordingly, there are sixteen “base questions” or “base statements” in total.

Each of these sixteen base statements is presented or displayed to the member in at least two contrasting ways which may include a first question asked in an experience based context and another question asked in a desire based context.

For example, the first question may include the preamble “how often do you experience the” followed by the [base statement] and the second question may have the preamble “how often do you desire the” followed by the [base statement]. The [base statement] being one of the subcategory statements present in Table 4 or FIGS. 4a to 4c from at least one relevant assessment type (i.e. 1, 2a, 2b, 2c, 3a, 3b, 3c).

This presents to the member a “desire” based question and an “experience” based question for each performance subcategory. Accordingly, in this example, there are 32 questions in total. It is noted that “desire” may be replaced with “want” and “experience” may be replaced by “receive” or similar wording to evoke a similar differentiating response.

For each of the thirty two questions provided to each user, the user is prompted to assign a valve to the question. In this example, the users are asked rank each questions ranged from ‘Never’ to ‘Always’ providing a percentile score. For example, the following scale of five ranges may be used:

Never=0% of the time;

Infrequently=about 25% of the time;

Sometimes=about 50% of the time;

Frequently=about 75% of the time; and

Always=95%+ of the time.

Referring to Table 5, example “desire” results and “experience” results have been provided for a single user. These questions are a subset of the questions provided in Table 4.

In this example, the user has provided series of scores or valves to the category 1 questions and a discrepancy or difference value has been determined. For example, taking sub-category 1.1, the user has answered the “question” based performance driver questions indicating they “desire” the question based performance driver 75% of the time, but only “experience” the question based performance driver 25% of the time.

If the experience results are subtracted from the desire results (i.e. DISCREPANCY %=D %-E %) then a discrepancy of difference value is obtained for each sub-category performance driver. For each set of performance drivers this provides sixteen discrepancy values or score.

Again, taking sub-category 1.1 as an example, the difference is +25%. The meaning of these values is further detailed below. However, in general terms, a positive discrepancy means that user actually desires the performance driver more than the user experiences the performance driver which may indicate a short coming in the company, leader or team (depending on Assessment type 2a, 3a etc).

As will be further detailed below, further calculations may be performed on the data set. For example, for a category the experience and desire results may be consolidated or averaged. In the example shown in Table 5, an additional row has been inserted to show the category 1 average discrepancy of +14%. Again, this may indicate a short coming of the organization (as this example relates to the 3a —CPI Assessment type) in relation to the investigation category. Similar consolidated or averaged results may be provided for the other category (2 to 4) such that consolidated or averaged discrepancy metrics or indexes may be provided for each category.

The above calculations have been simplified for example purposes. However, the method and results may be utilized for any number of users and typically the number of users may range from 100 to 100,000.

TABLE 5
Example Member Input to a selection
of questions and discrepancy calculation

| | | | Desire | Experience | |
|---|---|---|---|---|---|
| | | | Results | Results | |
| | | | How | How | |
| | | | often do | often do | |
| | | | you | you | |
| | | Assessment | desire | experience | |
| | | Type 3a- | from | from | |
| | | Company | your | your | Dis- |
| | | performance | company | company | crep- |
| | | Indicator | . . . | . . . | ancy |
| | | (CPI)-base | [base | [base | or |
| Cate- | Sub- | statements or | statement]. | statement]. | Differ- |
| gory | category | questions. | (%) | (%). | ence |
| 1- | 1.1- | an | 75 | 50 | +25 |
| investi- | Ques- | environment | | | |
| gation | tion | that | | | |
| | | encourages | | | |
| | | employees to | | | |
| | | provide input | | | |
| | | based on their | | | |
| | | knowledge and | | | |
| | | experience | | | |
| 1- | 1.2- | An | 75 | 75 | 0 |
| investi- | Im- | environment | | | |
| gation | prove | where | | | |
| | | employees are | | | |
| | | directly | | | |
| | | involved in the | | | |
| | | identification | | | |
| | | of ideas to | | | |
| | | improve | | | |
| | | product(s), | | | |
| | | service(s) or | | | |
| | | internal | | | |
| | | processes | | | |
| 1- | 1.3- | Working with a | 95 | 25 | +75 |
| investi- | Auton- | competent | | | |
| gation | omy | workforce that | | | |
| | | can perform | | | |
| | | tasks with | | | |
| | | minimal to no | | | |
| | | guidance | | | |
| 1- | 1.4- | Decisions that | 50 | 75 | −25 |
| investi- | Solve | are based upon | | | |
| gation | | sufficient | | | |
| | | information, | | | |
| | | analysis, facts | | | |
| | | and experience | | | |
| Cate- | | | 59 | 45 | +14 |
| gory 1- | | | | | |
| Aver- | | | | | |
| ages | | | | | |

Referring now to Table 6, there is shown consolidated results for a group of users to a series of performance drivers. For example, these results may have been generated from a member inputting a numerical score value in response to the questions shown in Table 4 or in FIGS. 4a to 4c. In this example, the previously described categories 1 to 4 and associated performance drivers have been used. In addition, there are custom categories, which may ask additional questions of interest to a particular user or group.

As will be further detailed below, these results are generated by the computer system 100 providing and recording data from a large set of users, for example, there may be 100,000 users. The responses for each user (i.e. values for desire and experience for each assessment) are stored, typically in the database 108, and then once the data has been collected from the users, calculations are performed using the processor 102 to provide the discrepancy assessment such as that shown in Tables 5 and 6.

The members are also associated with a member tier value and a member type. Therefore, the results shown in FIG. 4, may be selectively generated for a particular member type (i.e. workforce WF) or for a particular member tier value such as the marketing department located in North Sydney. (i.e. code 1.2.1 which would equate in the example above to the marketing department in North Sydney).

TABLE 6
Example Discrepancy Assessment
for a Number of Users in a Layer (i.e Layer 3a).

| Category | Sub Category | Desire | Experience | |
|---|---|---|---|---|
| (1 to 4 + Custom) | (1.1 to 4.4) | Based | Based | Discrepancy |
| Investigation | Solve | 83.33% | 63.33% | 20.00% |
| Investigation | Question | 80.00% | 61.67% | 18.33% |
| Investigation | Improve | 75.00% | 61.67% | 13.33% |
| Investigation | Autonomy | 75.00% | 66.67% | 8.33% |
| Motivation | Environment | 88.33% | 60.00% | 28.33% |
| Motivation | Resilience | 88.33% | 61.67% | 26.67% |
| Motivation | Action | 83.33% | 60.00% | 23.33% |
| Motivation | Feedback | 81.67% | 61.67% | 20.00% |
| Collaboration | Resolve | 80.00% | 65.00% | 15.00% |
| Collaboration | Trust | 83.33% | 70.00% | 13.33% |
| Collaboration | Unify | 78.33% | 66.67% | 11.67% |
| Collaboration | Coach | 66.67% | 71.67% | −5.00% |
| Orchestration | Accountability | 83.33% | 61.67% | 21.67% |
| Orchestration | Results | 83.33% | 65.00% | 18.33% |
| Orchestration | Structure | 80.00% | 63.33% | 16.67% |
| Orchestration | Alignment | 78.33% | 68.33% | 10.00% |
| Custom | Award System | 85.71% | 34.29% | 51.43% |
| Custom | Relations | 82.00% | 32.00% | 50.00% |
| Custom | Diversity | 82.14% | 37.86% | 44.29% |

Referring to Table 7 below, the data shown in Table 6 may also be further processed by computer system 100 to a consolidated form. For example, in Table 7, experience and desire values in each of the subcategories (i.e. experience values for subcategory 2.1 to 2.4 and desire values for subcategory 2.1 to 2.4) have been averaged and then used to calculate a consolidated category level discrepancy or difference value or index.

TABLE 7
Example of Consolidated Results

| | Desire | Experience | Discrepancy |
|---|---|---|---|
| Categories | Based | Based | Metric |
| 1. Investigation | 78.33% | 63.34% | 15.00% |
| 2. Motivation | 85.42% | 60.84% | 24.58% |
| 3. Collaboration | 77.08% | 68.34% | 8.75% |
| 4. Organization | 81.25% | 64.58% | 16.67% |
| 5. Custom | 83.28% | 34.72% | 48.57% |

The data such as that shown in Table 7, may be displayed to a member or administration user in a table, a graph or other format to allow processed and transformed data to be displayed as a useful product. The display to the user may be via a display device such as display device 142, via a remote client terminal display or a printed result.

The reporting and output of the analysis are further detailed below.

### The Output Reports and Products

The results are analysed using a 5-point likert scale combined with percentile ranking as an easy way to convey desire vs. experience (or preference/focus) for each area. There is no universally accepted definition of “percentile”, therefore the following criteria have been adopted:

| | |
|---|---|
| Never = | approximately 1% to 10% of the time |
| Infrequently = | approximately 11% to 25% of the time |
| Sometimes = | approximately 26% to 55% of the time |
| Most of the time = | approximately 56% to 80% of the time |
| Always = | approximately 81% to 100% of the time |

It is noted that ranks are written to the nearest whole percent: 74.5%=75%=75th, the scores are divided into 100 equally sized groups and there is no Zero percentile rank—the lowest score is at the first percentile.

The results are processed by the computer system 100 to provide a company with a clear picture on the business drivers that are supporting and hindering work culture, from the results link each business drivers to a training outcome therefore prioritising what the company, manager and team need to immediately focus on (in terms of training/coaching) to align the workplace culture.

Referring to FIG. 9, there is shown an example output in the form of a report 340 which may be generated from the methods 400, 500 and 600. The report 340 includes a wheel graph 350 which shows the averaged results to each of the performance criteria questions which in this example are provided in the form of sixteen subcategory performance drivers for the plurality of members. There is also shown a table 360 which includes desire (D) and experience (E) results for the series of custom performance driver questions. The results are ranked form greatest difference to lowest difference to highlight the key performance drivers which require attention in the company.

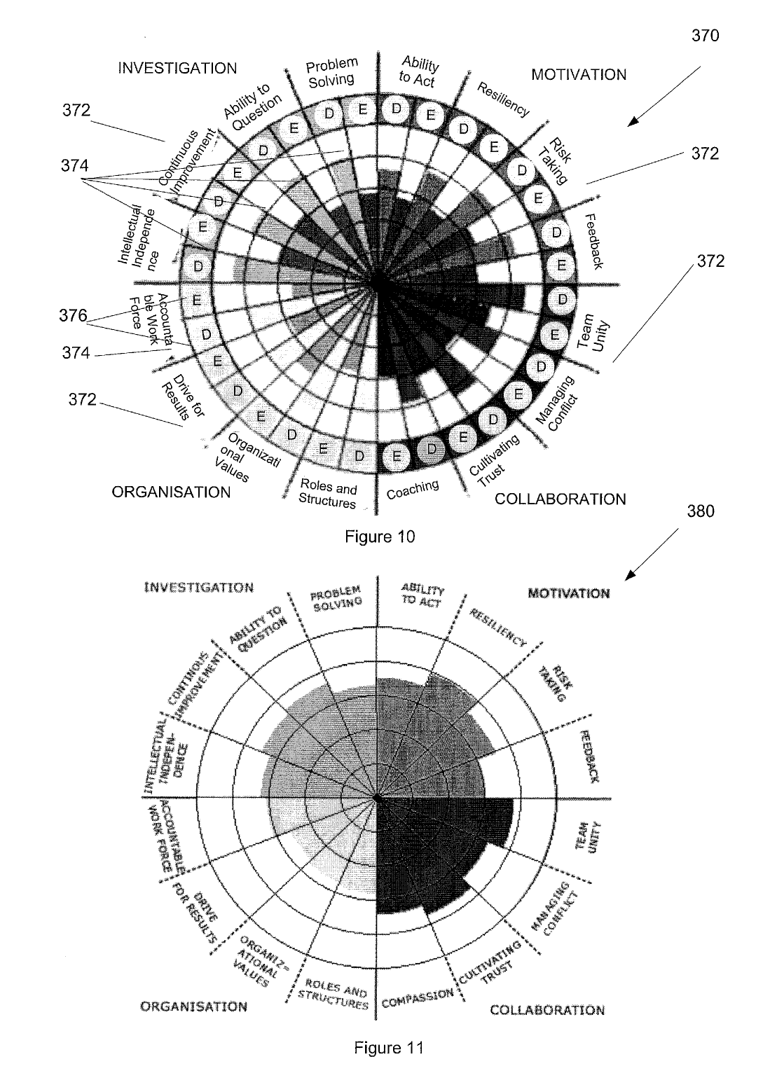

Referring to FIGS. 10 and 11, there are shown wheel charts or graphs which graphically display the results of the methods 400, 500 and 600.

FIG. 10, shows chart 370, which shows the desire “D” and experience “E” results, or first and second average scores, for each of the thirty two performance criteria questions which have been arranged in quadrants 372 according to the four categories. Each quadrant 372 is then divided into four segments 374 to display the results associated with each of the sixteen subcategories of performance drivers or statements. Each of the segments 374 is then divided into half segments 376. Each of the half segments are configured to respectively display, in this example, desire “D” and experience “E” results associated with the performance statement of the segment. This data is shown and may be derived from the first four columns of Table 6 presented above.

FIG. 11, shows a similar chart 380. However, in this chart the discrepancy metric of each of the desire “D” and experience “E” values shown in chart 370, has been calculated for each of the sixteen subcategories of performance drivers. This highlights to company management which performance areas require attention in the company. This may be used to show the fifth and final column discrepancy data of Table 6 presented above.

Referring to FIGS. 12a to 12d, there is shown a series of four bar charts 375 for each of the main four performance drivers being: 1. Innovation, 2: Collaboration, 3: Organisation and 4: Motivations. These may be interchanged to be the same as those shown as the main performance drivers and subcategories performance statements shown in Table 4 above. The charts display the output data to show averaged results for the four associated performance drivers. For example, FIG. 12a relates to the main performance driver “1. innovation” and the sub-category performance drivers “1.1: Autonomy”, “1.2: Improver”, “1.3: Question” and “1.4: Solve” whereby the sub-category performance drivers have been presented to the user in two contrasting ways to provide desire “D” and experience “E” based results data. The calculated discrepancy or gap between the desire and experience based results data is presented along side the desire and experience based data for comparative purposes.

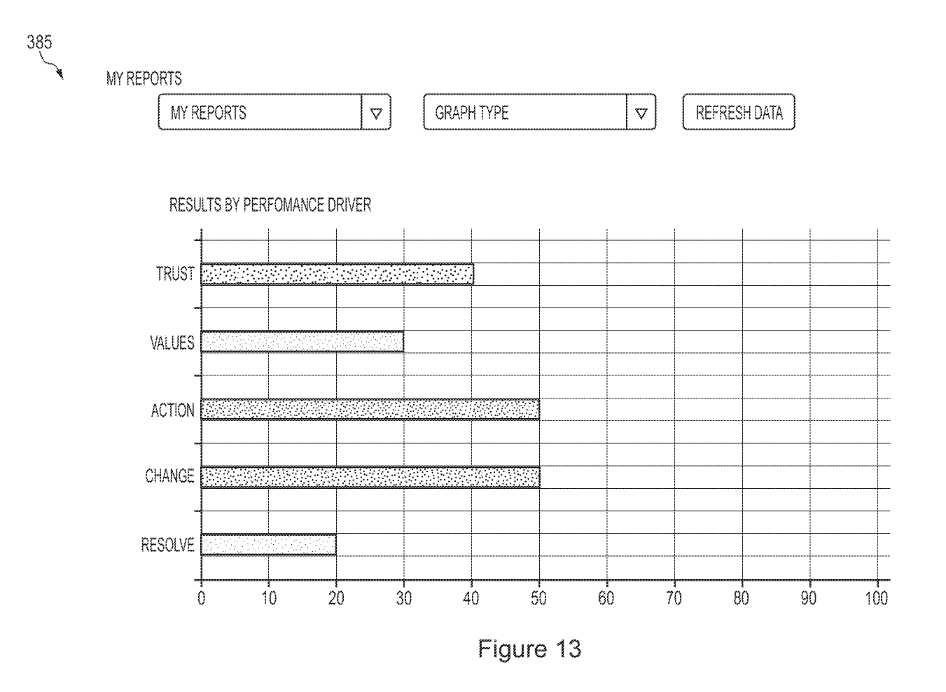

Referring to FIG. 13, there is shown another example of a chart 385 in the form of a bar chart to display the performance drivers. The bar chart is used to highlight features of the calculated data that require attention in the company. In this example, the results show that discrepancy value of 50% in relation to the “Action” performance driver.

Referring to FIG. 14, there is shown another example of a chart 390 to display the performance drivers. In this example, the calculation for the discrepancy metric has been conducted for a middle management employee (i.e. member type being MM). The results have also been ranked and truncated to shown the top five performing areas. The results are shown graphically in wheel graph 387 and in table format in table 389.

Referring to FIG. 15, there is shown another example of a chart 395 to display the completion rates of the assessment. In this example, the graphs show the completion rate for different tiers of the organisation.

Referring to FIG. 16, there is shown an example report 392 including wheel graph including output results for a senior executive team (SE) member type 393 and middle management (MM) member type 394. The example report 392 also includes a comparison wheel graph 397 which shows a discrepancy metric between the senior executive member type (SE) and the middle manager (MM) member type results.

The results also include a selection of the top five discrepancy results which are shown in Tables 399 include a first column with the four categories and a second column with the subcategories, also known as performance drivers. The second and third columns of the table show the result scores of member types from the senior executive (SE) and the middle manager (MM) member types. The final column shows the discrepancy, identified by numeral 396, between the SE results and the MM results. The discrepancies may be calculated by subtracting the MM results values from the SS the results values.

Accordingly, a comparison can be made between the MM and SE member type and identify to performance drivers the discrepancy relates. Similar reporting functionality is possible between other member types, for example, workforce (WF) member types and middle manager (MM) member types. The comparison data may be analysed from the raw average datasets for each member or calculated from averaged datasets.

In view of the above methods, 400, 500, 600, 700 it may be appreciated that an assessment method which provides a company wide assessment tool has been provided. The method may assign or associate particular members having a particular member type with a particular assessment type. The method then delivers or presents a set of questions to that member which may be specific to the member. Furthermore, the method may include member data having a member tier value whereby a member is assigned or associated with identifying tier code based on organisation structure such as location and cost centre function. These functionalities enable particular members or group of members to be identified and isolated in resultant data sets for analysis purposes to provide valuable insight into the response to the performance driver based questions which each member is asked to score with a numerical value. For example, comparisons may be between groups of members of having different member types or having different member tier values.

In particular, the above methods, 400, 500, 600, 700 may include providing a series of questions including a base statement which is presented to the employee in two contrasting ways, for example, a desire based question and an experience based question. Advantageously, this allows two values to be collected in relation to each base statement which in a preferred form are sixteen performance statements or drivers. The difference or discrepancy value otherwise known as a discrepancy metric may then be calculated for each member for each performance statement. Average discrepancy metrics may also be calculated, for example, for all members of a particular member type or member tier value. Average discrepancy metrics may also be calculated for the performance categories or quadrant to which the sixteen performance statements or drivers relate. These average values may be shown independently or comparatively by graphs, charts or tables such as this shown in FIGS. 9 to 14 and are used to measure and assess the performance of the company and draw out which of the performance categories and/or sixteen performance statements or drivers require the most urgent attention thereby providing a valuable tool to upper company management.

Each of the above methods 400, 500, 600, 700 the assessment data or questions set data may be based on the sixteen base statements or performance drivers and include over five types or layers of management/workforce architecture to allow for cross evaluation and discrepancy analysis. For example, if a company A has 10,000 employees, within the company structure is: 909 teams, 300 departments, 60 division, 12 offices, 5 countries, 3 regions, 1 global business, the company will ultimately have 1281 unique codes for the company. These results may be shown independently or comparatively by graphs, charts or tables such as this shown in FIGS. 9 to 14.

Accordingly, it should be appreciated that the above described methods and computer system operate on large and potentially distributed data set and perform calculations, data operations and transformations on these large data sets to provide company wide performance metrics, values or indexes which may be ranked, viewed or analysed against an range of criteria such as the employee type, employee tier value, performance categories or quadrants (1 to 4) and performance driver subcategories (1.1 to 4.4).

The reference in this specification to any known matter or any prior publication is not, and should not be taken to be, an acknowledgment or admission or suggestion that the known matter or prior art publication forms part of the common general knowledge in the field to which this specification relates.

While specific examples of the invention have been described, it will be understood that the invention extends to alternative combinations of the features disclosed or evident from the disclosure provided herein.

Many and various modifications will be apparent to those skilled in the art without departing from the scope of the invention disclosed or evident from the disclosure provided herein.

1. A computer system for assessing the performance of an organisation in relation to a series of performance criteria questions presented to a plurality of members of the organisation, the computer system being configured by a computer program to perform the following steps:
loading, in memory, member data and assessment data;
assigning, in a processor, an assessment type to each of the plurality of members using the member data and the assessment data;
sending, via an interface, question data including the series of performance criteria questions to each of the plurality of members, the series of performance criteria questions include a set of performance statements and each of the set of performance statements are provided in contrasting ways such that each of the plurality of members provides two input scores for each of the set of performance statements;
receiving, via the interface, input scores including two scores for each of the set of performance statements;
storing, in a storage device, the input scores for each of the plurality of members as results data, the results data being associated with at least one of the assessment type and the performance statements;
processing, in a processor, the results data from the plurality of members to provide output data by calculating an average difference between the two scores for each of the performance statements thereby providing a discrepancy metric for each of the set of performance statements, and
sending, via the interface, the output data including the discrepancy metric representing the performance of the organisation in relation to the series of performance criteria questions presented to the plurality of members.

2. The computer system according to claim 1, wherein the step of processing includes:
calculating, an average of the first of the two input scores for each of the set of performance statements for the plurality of members to provide a set of first averaged values for each of the set of performance statements;
calculating, an average of the second of the two input scores for each of the set of performance statements for the plurality of members to provide a second set of averaged values for each of the set of performance statements; and
wherein the output data includes the first set of averaged values, the second set of averaged values, the discrepancy metric and the associated set of performance statements.

3. The computer system according to claim 1, wherein the member data includes member types including at least a first member type and a second member type, and wherein in the step of processing, the discrepancy metric for each of the performance statements is associated with the member types of each of the plurality of members.

4. The computer system according to claim 3, wherein the output data includes the discrepancy metrics for the first member type and the second member type.

5. The computer system according to claim 4, wherein at the step of processing, a further discrepancy metric calculated by determining the difference between the discrepancy metric for the first member type and the second member type.

6. The computer system according to claim 4, wherein the member types include a workforce member, middle management member and a senior executive member, wherein first member includes at least one said member types and the second member type includes at least one other of the said member types.

7. The computer system according to claim 1, wherein the set of performance statements are subcategories of a main set of performance categories; and
wherein the step of processing includes calculation of a consolidated discrepancy metric for each of the main set of performance categories by calculating an average discrepancy metric of each of the set of performance statements associated with a particular one of main set of performance categories; and
wherein the output data includes the consolidated discrepancy metric for each of the main set of performance categories.

8. The computer system according to claim 7, wherein in the step of processing, the performance statements are ranked according to the value of the discrepancy metric for each of the performance statements; and
wherein the output data includes the ranked performance statements.

9. The computer system according to claim 1, wherein the two contrasting ways of presenting the performance statement include presenting each performance statement as a desire based question and an experience based question; and wherein the discrepancy metric is determined by subtracting the input score of the experience based question from the input score of the desire based question.

10. The computer system according to claim 1, wherein at the step of sending the question data, a first set of the selection of the series of performance criteria questions are sent to each of the plurality of members at a first time and a second set of the series of performance criteria questions are sent to each of the plurality of members at a second time.

11. The computer system according to claim 10, wherein the first set includes first questions presented to each of the plurality of members in one of the two contrasting ways and the second set includes second questions presented to each of the plurality of members in the other of the two contrasting ways.

12. A client computing device for assessing the performance of an organisation in relation to a series of performance criteria questions presented to a plurality of members of the organisation, the client computing device including a network interface for sending and receiving data and being in communication, across a data network, to the computing system as claimed in claim 1.

13. The computer system according to claim 1, wherein the computer system is a webserver.

14. A computer system for assessing the performance of an organisation in relation to a series of performance criteria questions presented to a plurality of members of the organisation, the computer system being configured by a computer program to perform the following steps:
loading, in memory, an assessment type including the series of performance criteria questions;
sending, via an interface, question data including the series of performance criteria questions to each of the plurality of members, the series of performance criteria questions including a set of performance statements, wherein each of the set of performance statements is arranged to provide two associated contrasting statements;
receiving, via the interface, input scores including two scores for each of the two associated contrasting statements of the set of performance statements;
storing, in a storage device, the input scores for each of the members as results data, the results data being associated with at least one of the assessment type and the performance statements;
processing, in a processor, the results data from the plurality of members, to provide output data by calculating an average difference between the two scores for each of the performance statements thereby providing a discrepancy metric for each performance statement, and
sending, via the interface, the discrepancy metric so as to indicate the performance of the organisation in relation to the series of performance criteria questions presented to the plurality of members.

15. The computer system according to claim 14, wherein the step of processing includes:
loading the results data for the plurality of members;
calculating, an average of the first of the two input scores for each of the set of performance statements for the plurality of members to provide a set of first averaged values for each of the performance statements;
calculating, an average of the second of the two input scores for each of the set of performance statements for the plurality of members to provide a second set of averaged values for each of the performance statements;
calculating, the discrepancy metric by determining the difference between the set of first averaged values and the second set of averaged value thereby providing an average discrepancy metric for each of the performance statements.

16. The computer system according to claim 15, wherein at the step of processing, the performance statements are ranked according to the value of the discrepancy average metric for each of the performance statements; and
wherein the output data includes the ranked performance statements.

17. The computer system according to claim 14, wherein the two contrasting ways of presenting the performance statement include presenting each performance statement as a desire based question and an experience based question; and wherein the discrepancy metric is determined by subtracting the input score of the experience based question from the input score of the desire based question.

18. The computer system according to claim 14, wherein the computer system is a webserver.

19. A computer readable medium for assessing the performance of an organisation in relation to a series of performance criteria questions presented to a plurality of members of the organisation, the computer readable storage medium having computer program code instructions recorded thereon, the computer program code instructions including:
instructions for loading, in memory, an assessment type including the series of performance criteria questions;
instructions for sending, via an interface, question data including a series of performance criteria questions to each of the plurality of members, the series of performance criteria questions including a set of performance statements, wherein each of the set of performance statements is arranged to provide two contrasting statements;
instructions for receiving, via the interface, input scores including two scores for each of the two associated contrasting statements for each of the set of performance statements;
instructions for storing, in memory, the input scores for each of the plurality of members as results data, the results data being associated with at least one of the assessment type and the performance statements;
instructions for processing, in a processor, the results data from the plurality of members, to provide output data by calculating an average difference between the two scores for each of the performance statements thereby providing a discrepancy metric for each performance statement, and
instructions for sending, via the interface, the discrepancy metric so as to indicate the performance of the organisation in relation to the series of performance criteria questions presented to the plurality of members.

20. A computer implemented method for assessing the performance of an organisation in relation to a series of performance criteria questions presented to a plurality of members of the organisation, the method utilising a computing system which is configured by a computer program to perform the following steps:
loading, in memory, an assessment type including the series of performance criteria questions;
providing, via an interface, the series of performance criteria questions to each of the plurality of members, the series of performance criteria questions including a set of performance statements and each performance statement is presented to each of the members in two contrasting ways such that the member provides two input scores for each of the performance statements;
recording, in memory, the two input scores for each of the plurality of members in response to each of the set of performance statements;
storing, in a database, the two input scores as results value data, the values being associated with at least one of the assessment type and the performance statements;
processing, in the processor, the results data from the plurality of members, to provide output data by calculating an average difference between the two scores for each performance statements thereby providing a discrepancy metric for each performance statement, and
providing, via a data output, the discrepancy metric so as to indicate the performance of the organisation in relation to the series of performance criteria questions presented to the plurality of members.
